(19) United States
(12) Patent Application Publication
(10) Pub. No.: US 2008/0241732 A1
(43) Pub. Date: Oct. 2, 2008

(54) THERMAL TRANSFER IMAGE-RECEIVING SHEET AND METHOD FOR PRODUCING IT

(75) Inventors: Junichiro Hosokawa, Kanagawa (JP); Kiyoshi Irita, Kanagawa (JP); Shinichiro Morimoto, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/057,590

(22) Filed: Mar. 28, 2008

(30) Foreign Application Priority Data
Mar. 30, 2007 (JP) 2007-092497

(51) Int. Cl. G03G 5/12

(52) U.S. Cl. 430/200; 430/270.1

(57) ABSTRACT

A thermal transfer image-receiving sheet comprising, on a support, at least one image-receiving layer containing at least one polymer latex and comprising at least one heat-insulating layer between the receiving layer and the support, wherein at least one layer on the support is formed by water-base coating and at least one layer on the support contains a defoaming agent.

### BACKGROUND OF THE INVENTION

1. Field of the Invention

The present invention relates to a thermal transfer image-receiving sheet and a method for producing it; and precisely, it relates to a thermal transfer image-receiving sheet capable of reducing the failure in the formed image and improving the print image quality, and to a method for producing it.

2. Background Art

Heretofore, various thermal transfer recording methods are known; and above all, a dye diffusion transfer recording system is specifically noted as a process capable of producing color hard copies of which the image quality is the nearest to that of the images of silver salt photographs (for example, see “New Development of Information Recording (hard copy) and its Material”, issued by Toray Research Center, 1993, pp. 241-265; and “Development of Printer Material”, issued by CMC, 1995, p. 180). In the dye diffusion transfer recording system, a dye-containing thermal transfer sheet (hereinafter this may be referred to as “ink sheet”) and a thermal transfer image-receiving sheet (hereinafter this may be referred to as “image-receiving sheet”) are put one upon another, then the ink sheet is heated with a thermal head from which the heat generation is controlled by an electric signal applied thereto to thereby transfer the dye from the ink sheet to the image-receiving sheet for image information recording thereon. In the system, three colors of cyan, magenta and yellow may be transferred and recorded as overlaid, thereby giving a color image having a continuous color density gradation. Accordingly, the obtained image has excellent intermediate color reproducibility and gradation expressibility, and the system may give an image of extremely high definition.

Moreover, the system has various advantages in that it is a dry system, it enables direct visual image formation from digital data, it facilitates image duplication, and as a full-color hard copy system, its market is expanding.

In the dye diffusion transfer system, an ink sheet and an image-receiving sheet are put one upon another to transfer the dye from the former to the latter. Accordingly, in this, it is necessary that both the ink sheet and the image-receiving sheet have good surface smoothness and that the ink sheet and the image-receiving sheet can be kept in airtight contact to each other with no gap therebetween while a thermal head is applied thereto under pressure. For this, in addition to the smoothness of the two, the cushionability of the image-receiving sheet is important. If the surface smoothness and the cushionability thereof is poor, then the image-receiving sheet could not be kept in airtight contact to the ink sheet in some area, thereby causing dye transfer failure.

Heretofore, a composite support comprising a microvoids-having biaxially-stretched polyolefin film was tried for the image-receiving sheet in order that the sheet could be cushionable (for example, U.S. Pat. No. 866,282 and J-AV 3-26B99B). Known is a method of forming a receiving layer on the support, by dissolving a receiving polymer in an organic solvent followed by applying the solution onto the support.

In the invention, a method of fabricating an image-receiving sheet in a water-base system has been investigated from the standpoint to the environment side of reducing the release of organic solvent in the environment and reducing the influence of organic solvent on human bodies in production.

In producing an image-receiving sheet in a water-base coating system, a method of using surfactant or the like to lower the surface tension of the coating liquid, thereby reducing the repelling failure in coating and improving the coatability is widely tried. However, the use of surfactant has a problem on the other hand, in that the coating liquid may readily form bubbles when stirred.

In particular, in case where the image-receiving layer is formed by the use of a polymer latex as in the present invention, the formation of bubbles is problematic in that it greatly worsens the image quality of prints.

Though not clear, this may be because of the following reasons. The first is that, when bubbles are formed in the above latex system, the surface skin of the bubbles may cause fish eyes. The second is that it has been known that the thermal diffusion transfer system is more readily influenced by fine bubbles as compared with conventional silver salt photographic systems.

In case where a heat-insulating layer is formed by the use of a hollow polymer-containing water-base system, there occurs a problem in that the formed bubbles worsen the image quality of prints. It has been known that the reason is because the hollow polymer concentrates in the surface of the bubbles and is concentration is promoted therein.

The present invention is to overcome the above-mentioned problems and to attain good finish in printing.

JP-A 6-268998 describes a method of preventing the generation of bubbles in forming a resin layer by the use of an organic solvent system, but this is silent on a method of improving the image quality of prints that may specifically worsen when a polymer latex system or a hollow polymer as in the present invention is used. In addition, this is also silent on the remarkable effect of the present invention that is characterized by the technique of simultaneous multilayer formation by Coating in a water-base system.

### SUMMARY OF THE INVENTION

The present inventors have assiduously studied and specifically considered the environmental load and the safety of the organic solvent (especially highly-volatile organic solvent) that is used in a large quantity in producing a thermal transfer image-receiving sheet having at least an image-receiving layer and a heat-insulating layer on a support, and have tried a production method of forming those layers according to a water-base coating system. Concretely, in the production method, a polymer latex is incorporated in the image-receiving layer and a hollow polymer is in the heat-insulating layer, and these layers are formed according to a water-base coating system. We have known that the problem specific to the method is that, when a polymer latex is used in the image-receiving layers the bubbles of the coating liquid greatly worsen the image quality of prints. In addition, we also have known that, when a hollow polymer is incorporated into the heat-insulating layer, then the bubbles of the coating liquid also greatly worsen the image quality of prints. So as prevent the formation of the bubbles in the coating liquids, we have further assiduously studied and, as a result, have found that the above-mentioned objects of the invention can be attained by the following means.

Specifically, the above-mentioned objects can be attained by the following means:

(1) A thermal transfer image-receiving sheet having, on a support, at least one image-receiving layer containing at least one polymer latex and having at least one heat-insulating layer between the receiving layer and the support, wherein at least one layer on the support is formed by water-base coating and at least one layer on the support contains a defoaming agent.

(2) The thermal transfer image-receiving sheet of the above (1), wherein the heat-insulating layer contains at least one hollow polymer and is formed by water-base coating.

(3) The thermal transfer image-receiving sheet of the above (2), wherein at least two layers on the support are formed by simultaneous multilayer coating.

(4) A method for producing a thermal transfer image-receiving sheet having, on a support, at least one image-receiving layer containing at least one polymer latex and having at least one heat-insulating layer between the receiving layer and the support, and containing a defoaming agent in at least one layer on the support, which comprises forming at least one layer on the support by water-base coating.

(5) The method for producing a thermal transfer image-receiving sheet of the above (4), wherein the heat-insulating layer contains at least one hollow polymer and the heat-insulating layer is formed by water-base coating.

(6) The method for producing a thermal transfer image-receiving sheet of the above (4) or (5), wherein at least two layers on the support are formed by simultaneous multilayer coating.

The thermal transfer image-receiving sheet of the invention may produce a record image having few failures inside the image and having better print image quality. The production method of the invention has the advantages of low environmental load, good safety and low cost.

### BEST MODE FOR CARRYING OUT THE INVENTION

The thermal transfer image-receiving sheet of the invention is described in detail hereinunder. The description of the constitutive elements of the invention given hereinunder is for some typical embodiments of the invention, to which, however, the invention should not be Limited. In this description, the numerical range expressed by the wording “a number to another number” means the range that falls between the former number indicating the lowermost limit of the range and the latter number indicating the uppermost limit thereof.

The thermal transfer image-receiving sheet of the invention has, on a support, at least one image-receiving layer (dye-receiving layer) and having at least one heat-insulating layer (porous layer) between the support and the receiving layer. Between the support and the receiving layer, interlayers such as a white background-controlling layer, a static charge-controlling layer, an adhesive layer, a primer layer and an undercoat layer may be formed.

In the invention, it is desirable that at least one receiving layer and at least one heat-insulating layer are formed by water-base coating. Preferably, these layers are formed by simultaneous multilayer coating. In case where the sheet has an interlayer, the receiving layer, the heat-insulating layer and the interlayer may be formed by simultaneous multilayer coating.

On the back of the support, preferably formed are a curl-controlling layer, a writing layer and a static charge-controlling layer. The layers on the back of the support may be formed by an ordinary method of roll coating, bar coating, gravure coating, gravure reverse coating or the like.

### <Defoaming Agent>

The defoaming agent for use in the invention means a compound which, in place of a foaming causative substance, exists by itself on the surface of liquid but which does not have by itself an effect of imparting repulsion resistant to thinning of bubble films. Concretely, for example, it includes alcohols, ethers, polyols, fatty acid esters, metal soaps, phosphates, silicones, and nonionic surfactants. Of commercially-available defoaming agents and compounds having the structure, any ones having a defoaming effect can be used either singly or as combined, or as their mixture.

### (A) Alcohols:

Fatty acid alcohols having from 1 to 10 carbon atoms are usable, including, for example, methanol, ethanol, butanol, octanol, 2-ethylhexanol.

However, fatty acid alcohols having from 1 to 3 carbon atoms must be added in an amount of at least 1% in order that they could positively express their effect, and they may swell and promote the coagulation of latex or hollow polymer. Accordingly, fatty acid alcohols having at least 4 carbon atoms are preferred.

### (B) Fatty Acid Esters:

These include isoamyl stearate, succinic diester, sorbitan monolaurate, sorbitan monooleate, sorbitan trioleate, oxyethylene sorbitan monolaurate, diethylene glycol distearate, low-molecular-weight polyethylene glycol oleate.

### (C) Ethers:

These include ethylene glycol monophenyl ether (e.g., di-tert-diaminophenoxyethanol), ethylene glycol dialkyl ether (e.g., 3-heptyl cellosolve, nonyl cellosolve), diethylene glycol dialkyl ether (e.g., 3-heptylcarbitol). Commercial products such as Bionin K-17 (by Takemoto Yushi) and Nopco DF122-NS (by Sannopco) are usable.

### (D) Polyocls:

These are compounds having many alkyleneoxide groups (especially ethyleneoxide groups) in the structure (e.g., polyethers), and as the compounds have excellent dispersion stability in water, they have an excellent defoaming effect in liquid. Commercial products of polyether-type defoaming agents are, for example, Adeka Pluronic Series, Adekanol Series LG-109, LG-121, LG-294, LG-297 (by Asahi Denka Kogyo), and SN Defoamer 157, 247, 375, 470 (by Sannopco).

### (E) Metal Soaps:

Various types organic acid metal salts are usable, including, for example, naphthenic acid-type metal soap, synthetic acid-type metal soap, and stearic acid-type metal soap. Concretely mentioned are aluminium stearate, and Naphthenate, Dicnate, Stearate (all by Dai-Nippon Ink Chemical Industry).

### (F) Silicones:

These include oil-type, compound-type, self-emulsification-type, or emulsion-type silicone defoaming agents. In particular, oil-type agents include not only ordinary dimethylpolysiloxane-structured silicone oil but also modified silicone oil in which the methyl group is partly modified. For example, there are mentioned various modified silicone oils such as amino-modified, epoxy-modified, carboxyl-modified, carbinol-modified, methacryl-modified, mercapto-modified, phenol-modified, heterofunctional group-modified, polyether-modified, methylstyryl-modified, alkyl-modified, higher fatty acid ester-modified, hydrophilic special-modified, higher alkoxy-modified, higher fatty acid-containing or fluorine-modified ones. As commercial products, oil-type agents include SE200 (by Toray Dow Corning Silicone), KF96, KSG04, KI-6702 (by Shin-etsu Silicone); compound-type agents include SN Defoamer 5016 (by Sannopco), SH5500, SC5540 (by Toray Dow Corning Silicone); self-emulsification-type agents include BY2S-503 (by Toray Dow Corning Silicone), KS508, KS530, KS-538 (by Shin-etsu Silicone); emulsion-type agents include SM5511, SM5512, SM5515 (by Toray Dow Corning Silicone), KM72, KM73, KM98 (by Shin-etsu Silicone). As modified silicone oil-type agents, amino-modified ones include SF5417; epoxy-modified ones include SFB411, SFB413; carboxyl-modified ones include BY16-990; fluorine-modified ones include FS1265 (all by Toray Dow Corning Silicone); polyether-modified ones include KF6017 (by Shin-etsu Silicone). FORM BAN MS-575 (by Ultra Additives Inc.) contains both alkyl-modified silicone and polyether-modified silicone. Carbinol-modified silicones include KF-6001, KF-6003 (by Shin-etsu Silicone).

### (G) Non-Ionic Surfactants:

The following examples are mentioned.

(1) Alkyl aryl ether/ethylene oxide adducts
(2) Compounds of a formula, HO—(C₂H₄O)n-(C₃H₆O)m-(C₂H₄O)ₙ—OH, having a molecular weight of from 500 to 10000, and having a C₂H₄O content of from Q to 55%.
(3) Alkyl ester-type compounds of a formula R¹(R²)CHCOO(C₂H₄O)n-R⁴(wherein R¹ and R² each represent an alkyl group having from 1 to 15 carbon atoms, n is from 1 to 8, R⁴ represents a hydrogen atom, or an alkyl group having from 1 to 15 carbon atoms). Preferably, R¹ and R² each are an alkyl group having at least 5 carbon atoms, more preferably at least 10 carbon atoms. Preferably, R⁴ is a hydrogen atom, or an alkyl group having from 1 to 4 carbon atoms, more preferably a hydrogen atom.
(4) Acetylenediols and their ethylene oxide (0 to 8 mols) adducts.

One or more of the defoaming agents may be used in the invention, singly or as combined, or as their mixture.

Of the above-mentioned defoaming agents (A) to (G), when used in a coating liquid that contains a polymer latex and a hollow polymer in the invention, the agents (F) may change the viscoelasticity of film thereby promoting the stickiness to ink sheet. The nonionic surfactants (G) are problematic in that their effect varies depending on the ambient temperature, and therefore, when the coating liquid is not under severe temperature control, then the surfactants could not exhibit their effect. Accordingly for use in the invention, the above defoaming agents (A) to (E) are preferred.

Regarding its amount, the defoaming agent must exhibit its defoaming effect not inducing coagulation of latex and hollow polymer; and therefore, the amount is preferably from 0.01 to 5% by mass relative to the coating liquid, more preferably from 0.1 to 1% by mass.

### (Image-Receiving Layer)

The image-receiving layer plays a role of receiving the dye transferred from an ink sheet and holding the formed image. The image-receiving sheet of the invention has at least one receiving layer that contains at least a thermoplastic receiving polymer capable of receiving a dye.

The receiving polymer is preferably used as a polymer latex, as dispersed in a water-soluble dispersion medium. Further preferably, the receiving layer contains a water-soluble polymer in addition to the polymer latex. Containing a polymer latex and a water-soluble polymer, the layer may have the hardly-dyeable water-soluble polymer as dispersed in the polymer latex therein, therefore acting to prevent the dye fixed on the polymer latex from diffusing away; and as a result, the sharpness of the image-receiving layer changes little with time and the transferred image is deteriorated little with time, or that is, the image-receiving sheet may form a good and fast record image.

The receiving layer may contain any other polymer latex having any other function, in addition to the receiving polymer latex, for example, for the purpose of controlling the film elasticity.

The receiving layer may contain any other additives such as UV absorbent, release agent, lubricant, antioxidant, preservative, surfactant.

### <Polymer Latex>

The polymer latex is described. In a thermal transfer image-receiving sheet, the polymer latex to be in the receiving layer is a dispersion of water-insoluble hydrophobic polymer particles dispersed in a water-soluble dispersion medium. The dispersion may be any one prepared by emulsifying a polymer in a dispersion medium, one prepared by emulsification and polymerization, one prepared by micelle dispersion, or a molecular dispersion of polymer molecules partially having a hydrophilic structure, in which the molecular chains themselves are molecularly dispersed. The polymer latex is described, for example, in Taira Okuda & Hiroshi Inagaki, “Synthetic Resin Emulsion”, issued by the Polymer Publishing, 1978; Takaaki Sugimura, Yasuo Iataoka, SoichL Suzuki, & Keiji Kasahara, “Applications of Synthetic Latex”¹, issued by the Polymer Publishing, 1993; Soichi Muroi, “Chemistry of Synthetic Latex”, issued by the Polymer Publishing, 1970; Yoshiaki Miyosawa, “Development and Application of Water-Base Coating Material”, by CMC, 2004; and JP-A 64-538. The mean particle size of the dispersion particles is preferably within a range of from 1 to 50000 nm, more preferably from 5 to 1000 nm. The particle size distribution of the dispersion particles is not specifically defined, and the particles may have a broad particle size distribution or may have a monodispersion particle size distribution.

The polymer latex may be an ordinary uniform-structured polymer latex, and in addition, it may also be a core/shell-structured polymer latex. In the latter case, it is often desirable that the core and the shell have a different glass transition temperature. The glass transition temperature of the polymer latex for use in the invention is preferably from −30° C. to 130° C., more preferably from 0° C. to 120° C. Among them, the glass transition temperature is preferably 40° C. or higher (more preferably 40° C. to 120° C.), still more preferably 70° C. or higher (more preferably 70° C. to 100° C.)

As preferred embodiments of the polymer latex, hydrophobic polymers are preferably used therein, including, for example, acrylic polymers, polyesters, rubbers (e.g., SER resin), polyurethanes, polyvinyl chlorides, polyvinyl acetates, polyvinylidene chlorides, polyolefins. These polymers may be linear polymers, or branched polymers, or crosslinked polymers, and they may be homopolymers formed by polymerization of a single monomer or copolymers formed by copolymerization of two or more different monomers. The copolymers may be random copolymers or block copolymers. Preferably, the number-average molecular weight of the polymer is from 5000 to 1000000, more preferably from 10000 to 500000. In case where a polymer having a too small molecular weight is used, the mechanical strength of the layer containing the polymer latex may be insufficient; but when a polymer having a too large molecular weight is used, then it is unfavorable since its film formability is poor. A crosslinked polymer latex is also preferably used in the invention.

Not specifically defined, the monomer for use in producing the polymer latex may be any one capable of polymerizing in an ordinary radical polymerization or ionic polymerization method. For example, preferred are those of the following monomer groups (a) to (j). From these monomers, any ones may be independently suitably selected and combined and used in producing the polymer latex for use herein.

—Monomer Groups (a) to (j)—
(a) Conjugated dienes: 1,3-pentadiene, isoprene, 1-phenyl-1,3-butadiene, 1-α-naphthyl-1,3-butadiene, 1-β-naphthyl-1,3-butadiene, cyclopentadiene, etc.
(b) Olefins: ethylene, propylene, vinyl chloride, vinylidene chloride, 6-hydroxy-1-hexene, 4-pentenoic acid, methyl 8-nonenoate, vinylsulfonic acid, trimethylvinylsilane, trimethoxyvinylsilane, 1,4-divinylcyclohexane, 1,2,5-trivinylcyclohexane, etc.
(c) α,β-unsaturated carboxylates: alkyl acrylates (e.g., methyl acrylate, ethyl acrylate, butyl acrylate, cyclohexyl acrylate, 2-ethylhexyl acrylate, dodecyl acrylate), substituted alkyl acrylates (e.g., 2-chloroethyl acrylate, benzyl acrylate, 2-cyanoethyl acrylate), alkyl methacrylates (e.g., methyl methacrylate, butyl methacrylate, 2-ethylhexyl methacrylate, dodecyl methacrylate), substituted alkyl methacrylates (e.g., 2-hydroxyethyl methacrylate, glycidyl methacrylate, glycerin monomethacrylate, 2-acetoxyethyl methacrylate, tetrahydrofurfuryl methacrylate, 2-methoxyethyl methacrylate, polypropylene glycol monomethacrylate (molar number of added polyoxypropylene=2 to 100), 3-N,N-dimethylaminopropyl methacrylate, chloro-3-N,N,N-trimethylammoniopropyl methacrylate, 2-carboxyethyl methacrylate, 3-sulfopropyl methacrylate, 4-oxysulfobutyl methacrylate, 3-trimethoxysilylpropyl methacrylate, allyl methacrylate, 2-isocyanatoethyl methacrylate) unsaturated dicarboxylic acid derivatives (e.g., monobutyl maleate, dimethyl maleate, monomethyl itaconate, dibutyl itaconate), polyfunctional esters (e.g., ethylene glycol diacrylate, ethylene glycol dimethacrylate, 1,4-cyclohexane diacrylate, pentaerythritol tetramethacrylate, pentaerythritol triacrylate, trimethylolpropane triacrylate, trimethylolethane triacrylate, dipentaerythritol pentamethacrylate, pentaerythritol hexaacrylate, 1,2,4-cyclohexane tetraacrylate), etc.
(d) α,β-unsaturated carboxylic acid amides: for example, acrylamide, methacrylamide, N-methylmethacrylamide, N,N-dimethylacrylamide, N-methyl-N-hydroxyethylinethacrylamide, N-tert-butylacrylamide, N-tert-octylmethacrylamide, N-cyclohexylacrylamide, N-phenylacrylamide, N-(2-acetacetoxyethyl)acrylamide, N-acryloylmorpholine, diacetonacrylamide, itaconic acid diamide, N-methylmaleimide, 2-acrylamide-methylpropanesulfonic acid, methylenebisacrylamide, dimethacryloylpiperazine, etc.
(e) Unsaturated nitriles; acrylonitrile, methacrylonitrile, etc.
(f) Styrene and its derivatives: styrene, vinyltoluene, p-tert-butylstyrene, vinylbenzoic acid, methyl vinylbenzoate, α-methylatyrene, p-chloromethylstyrene, vinylnaphthalene, p-hydroxymethylstyrene, sodium p-styrenesulfonate, potassium p-styrenesulfinate, p-aminomethylstyrene, 1,4-divinylbenzene, etc.
(g) Vinyl ethers: methyl vinyl ether, butyl vinyl ether, methoxyethyl vinyl ether, etc.
(h) Vinyl esters: vinyl acetate, vinyl propionate, vinyl benzoate, vinyl salicylate, vinyl chloroacetate, etc.
(i) α,β-unsaturated carboxylic acids and their salts: acrylic acid, methacrylic acid, itaconic acid, maleic acid, sodium acrylate, ammonium methacrylate, potassium itaconate, etc.
(j) Other polymerizing monomers: N-vinylimidazole, 4-vinylpyridine, N-vinylpyrrolidone, 2-vinyloxazoline, 2-isopropenyloxazoline, divinylsulfone, etc.

Polymer latex is commercially available, and the following polymers are usable. Examples of acrylic polymers are Daicel Chemical Industry's Sevian A-4635, 4718, 4601; Nippon Zeon's Nipol Lx811, 814, 821, 820, 855 (P-17: Tg 36° C.) 857×2 (P-18: Tg 43° C.); Dai-Nippon Ink Chemical's Voncoat R3370 (P-19: Tg 25° C.), 4280 (P-20: Tg 15° C.), Nippon Pure Chemicals' Jurymer ET-410 (P-21; Tg 44° C.), JSR's AE116; (P-22: Tg 50° C.), AE119 (P-23: Tg 55° C.), AE121 (P-24: Tg 58° C.), AE125 (P-25: Tg 60° C.), AE134 (P-26: Tg 48° C.), AE137 (P-27: Tg 48° C.), A7140 (P-28: Tg 53° C.), AE173 (P-29: Tg 60° C.), To a Gosei's Aron A-104 (P-30: Tg 45° C.), Takamatsu Yushi's NS-600X, NS-620X, Nisshin Chemical Industry's Vinybrani 2580, 2583, 2641, 2770, 2770H, 2635, 2886, 5202C, 2706 (all trade names).

Examples of polyesters are Dai-Nippon Ink Chemical's FINETEX ES650, 611, 675, 850, Eastman Chemcalts WD-size, WMS, Takamatsu Yushi's A-110, A-115GE, A-12O, A-121, A-124GP, A-124S, A-160P, A-210, A-215GE, A-510, A-513E, A-515GE, A-520, A-610, A-613, A-615GE, A-620, WAC-10, WAC-15, WAC-17XC, WAC-20, S-110, S-110EA, S-111SL, S-120, S-140, S-140A, S-250, S-252G, S-250S, S-320, S-680, DNS-63P, NS-122L, NS-122LX, NS-244LX, NS-140L, NS-1417X, NS-282LX, To a Gosei's Aron Melt PES-1000 Series, PES-2000 Series, Toyobo's Vylonal MD-1100, MD-1200, MD-1220, MD-1245, MD-1250, MD-1335, MD-1400, MD-1480, MD-1500, MD-1930, MD-1985, Sumitomo Seika's Ceporjon ES (all trade names).

Examples of polyurethanes are Dai-Nippon Ink Chemical's HYDRAN AP10, AP20, A230, AP40, 101H, Vondic 1320NS, 1610NS, Dainichi Seika's D-1000, D-2000, D-6000, D-4000, D-9000, Takamatsu Yushi's NS-155X, NS-310A, NS-310X, NS-311X, Dali-ichi Kogyo Pharmaceutical's Elastron (all trade names).

Examples of rubbers are LACSTAR 7310K, 33073, 4700H, 71320 (all by Dai-Nippon Ink Chemical), Nipol Lx416, LX410, LX430, LX435, LX110, LX415A, LX438C, 2507H, LX303A, LX407BP Series, V1004, M5055 (all by Wippon Zeon) (all trade names).

Examples of polyvinyl chlorides are Nippon Zeon's G351, G576, Nisshin Chemical Industry's Vinybran 240, 270, 277, 375, 386, 609, 550, 601, 602, 630, 660, 671, 683, 680, 680S, 681N, 685PR, 277, 380, 381, 410, 430, 432, 860, 863, 865, 867, 900, 900GT, 938, 950 (all trade names). Examples of polyvinylidene chlorides are Asahi Kasei's L502, L513, Dai-Nippon Ink Chemical's D-5071 (all trade names). Examples of polyolefins are Mitsui Petrochemical's Chemipearl S120, SA100, V300 (P-40: Tg 80° C.), Dai-Nippon Ink Chemical's Voncoat 2830, 2210, 2960, Sumitomo Seika's Zaikthene, Ceporjon G; and examples of copolymer nylons are Sumitomo Seika's Ceporjon PA (all trade names).

Examples of polyvinyl acetates are Nisshin Chemical Industry's Vinybran 1080, 1082, 1085W, 1108W, 1108S, 1563M, 1566, 1570, 1588C, A22J7-F2, 1128C, 1137, 1138, A20J2, A23J1, A23K1, A23P2E, A68J1N, 1086A, 1086, 1086D, 1108S, 1187, 1241LT, 1580N, 1083, 1571, 1572, 1581, 4465, 4466, 4468W, 4468S, 4470, 4485LL, 4495LL, 1023, 1042, 1060, 1060S, 1080M, 1084W, 1084S, 1096, 1570K, 1050, 1050S, 3290, 1017AD, 1002, 1006, 1008, 1107L, 1225, 1245L, GV-6170, GV-6181, 4468W, 4468S (all trade names).

One or more these polymer latexes may be used herein either singly or as combined.

In the invention, it is desirable that at least one receiving layer is formed by water-base coating; but in case where plural receiving layers are formed, it is more desirable that all of those receiving layers are formed by water-base coating followed by drying. “Water-base” as referred to herein means that at least 60% by mass of the solvent (dispersion medium) of the coating liquid is water. As the other component than water in the coating liquid, usable is a water-miscible organic solvent such as methyl alcohol, ethyl alcohol, isopropyl alcohol, methyl cellosolve, ethyl cellosolve, dimethylformamide, ethyl acetate, diacesonalcohol, furfuryl alcohol, benzyl alcohol, diethylene glycol monomethyl ether, oxyethyl phenyl ether.

Preferred examples of the polymer latex for use in the invention are polylactates, polyurethanes, polycarbonates, polyesters, polyacetals, SBRs, polyvinyl chlorides. Of those, most preferred are polyesters, polycarbonates, polyvinyl chlorides.

Of the above-mentioned polymer latexes, polyvinyl chlorides are preferred for use in the invention. Of polyvinyl chlorides, or that is, polymer latexes at least containing a repetitive unit derived from vinyl chloride, preferred are polymer latexes containing a repetitive unit derived from vinyl chloride in an amount of at least 50 mol %; and more preferred are copolymer latexes. For the copolymer latexes, the monomer copolymerizable with vinyl chloride is preferably acrylic or methacrylic acid or its ester, vinyl acetate, ethylene, more preferably acrylic or methacrylic acid or its ester, even more preferably acrylate. Preferably, the alcohol moiety of the ester part of the acrylate has from 1 to 10 carbon atoms, more preferably from 1 to 8 carbon atoms. The polyvinyl chlorides of the type include those mentioned in the above; and especially preferred are Vinybran 240, Vinybran 270, Vinybran 276, Vinybran 277, Vinybran 375, Vinybran 380, Vinybran 386, Vinybran 410, Vinybran 430, Vinybran 432, Vinybran 550, Vinybran 601, Vinybran 602, Vinybran 609, Vinybran 619, Vinybran 680, Vinybran 680S, Vinybran 691N, Vinybran 683, Vinybran 685R, Vinybran 690, Vinybran 860, Vinybran 863, Vinybran 685, Vinybran 867, Vinybran 900, Vinybran 938, Vinybran 950 (all by Nisshin Chemical Industry), SE1320, S-830 (both by Sumitomo Cheatec).

The polymer latex is used in the invention for the purpose of receiving the dye to be transferred from an ink sheet, and the polymer latex may be combined with any polymer.

The polymer to be combined may act to receive dye, but may serve as a binder that holds the polymer latex.

The polymer is preferably transparent or semitransparent and colorless, including natural resins, polymers and copolymers, and synthetic resins, polymers and copolymers, and other film-forming media, for example, gelatins, polyvinyl alcohols, hydroxyethyl celluloses, cellulose acetates, cellulose acetate butyrates, polyvinylpyrrolidones, casein, starch, polyacrylic acids, polymethyl methacrylates, polyvinyl chlorides, polymethacrylic acids, styrene-maleic anhydride copolymers, styrene-acrylonitrile copolymers, styrene-butadiene copolymers, polyvinyl acetals (e.g., polyvinyl formal, polyvinyl butyral) r polyesters, polyurethanes, phenoxy resins, polyvinylidene chlorides, polyepoxides, polycarbonates, polyvinyl acetates, polyolefins, polyamides. The binder may be formed from water or from an organic solvent or an emulsion by coating.

In case where a polymer latex is used essentially as the above-mentioned binder, apart from the polymer latex to be used for the purpose of receiving the dye transferred from an ink sheet, the polymer latex preferably has a glass transition temperature (Tg) falling within a range of from −30° C. to 70° C. from the working brittleness and the image storability, more preferably from −10° C. to 50° C., even more preferably from 0° C. to 40° C. Two or more polymers may be blended for the binder. In this case, it is desirable that the weighted mean Tg of the polymer blend formed in consideration of the composition thereof falls within the above range. In case where the blend has phase separation or a core/shell structure, it is also desirable that the weighted mean Tg thereof falls within the above range.

The glass transition temperature (Tg) may be computed according to the following formula:

1/Tg=Σ(Xi/Tgi)

In this, the polymer is formed through copolymerization of n's monomers from i=1 to n. Xi means the mass fraction of the i'th monomer (ΣXi=1); and Tgi means the glass transition temperature (absolute temperature) of a homopolymer of the i'th monomer. Σ is the sum of i=1 to n. For the glass transition temperature of the homopolymer of each monomer (Tgi), employed are the data in “Polymer Handbook (3rd Edition)” (by T. Brandrup, E. H. Immergut, Wiley-Interscience, 1989).

The glass transition temperature of the above-mentioned polymer latex and the hollow polymer to be mentioned below, which are for receiving dye in the invention, is defined as actual survey data, but may be estimated according to the above-mentioned computation method.

### <Water-Soluble Polymer>

The receiving layer-preferably contains a water-soluble polymer. The water-soluble polymer fur use in the invention includes natural polymers (from polysaccharides, microorganisms, animals), semisynthetic polymers (from cellulose, starch, alginic acid), and synthetic polymers (vinyl-type, others). Synthetic polymers such as polyvinyl alcohol to be mentioned below, as well as natural or semisynthetic polymers starting from vegetable-derived cellulose or the like correspond to the water-soluble polymer for use in the invention. The water-soluble polymer in the invention does not include the above-mentioned polymer latex.

In order to differentiate the water-soluble polymer from the above-mentioned polymer latex, the water-soluble polymer may be referred to as binder in the invention.

Of the water-soluble polymers usable in the invention, natural polymers and semisynthetic polymers are described in detail. The vegetable-derived polysaccharides include gum arabic, κ-carrageenan, ι-carrageenan, λ-carrageenan, guar gum (e.g., Squalon's Supercol), locust bean bum, pectin, tragacanth, corn starch (e.g., National Starch & Chemicals Purity-21), phosphorylated starch (e.g., National Starch & Chemical's National 78-1898); the microorganism-derived polysaccharides include xanthan gum (e.g., Kelco's Keltrol T), dextrin (e.g., National Starch & Chemical's Nadex360); the animal-derived natural polymers include gelatin (e.g., Croda's Crodyne B419), casein, sodium chondroitin sulfate (e.g., Croda's Cromoist CS) (all trade names). The cellulose-derived polymers include ethyl cellulose (e.g., I.C.I.'s Cellofas WLD), carboxymethyl cellulose (e.g., Daicel's CMC), hydroxyethyl cellulose (e.g., Daicel's HEC), hydroxypropyl cellulose (e.g., Aqualon's Klucel), methyl cellulose (e.g., Henkel's Viscontran), nitrocellulose (e.g., Hercules's Isopropyl Wet), cationated cellulose (e.g., Croda's Crodacel QM) (all trade names). The starch-derived polymers include phosphorylated starch (e.g., National Starch & Chemical's National 78-1898); the alginic acid-derived polymers include sodium alginate (e.g., Kelco's Keltone), propylene glycol alginate; and as other groups, usable are cationated guar gum (e.g., Alcolac's Hi-care1000), sodium hyaluronate (e.g., Lifecare Biomedial's Hyalure) (all trade names).

In the invention, gelatin is one preferred embodiment. Gelatin for use in the invention may have a molecular weight of from 10,000 to 1,000,000. Gelatin for use in the invention may contain an anion such as Cl⁻, SO₄²⁻, or may contain a cation such as Fe²⁺, Ca²⁺, Mg²⁺, Sn²⁺, Zn²⁺. Preferably, gelatin is added, after dissolved in water.

Of the water-soluble polymers for use in the invention, synthetic polymers are described in detail. The acrylic polymers include sodium polyacrylate, polyacrylic acid copolymer, polyacrylamide, polyacrylamide copolymer, polydiethylaminoethyl(meth)acrylate quaternary salt or its copolymer; the vinyl polymers include polyvinylpyrrolidone, polyvinylpyrrolidone copolymer, polyvinyl alcohol; and other polymers include polyethylene glycol, polypropylene glycol, polyisopropylacrylamide, polymethyl vinyl ether, polyethyleneimine, polystyrenesulfonic acid or its copolymer, naphthalenesulfonic acid condensate salt, polyvinylsulfonic acid or its copolymer, polyacrylic acid or its copolymer, acrylic acid or its copolymer, as well as maleic acid copolymer, monomaleate copolymer, acryloylmethylpropanesulfonic acid or its copolymer, polydimethyldiallylammonium chloride or its copolymer, polyamidine or its copolymer, polyimidazoline, dicyandiamide condensater epichlorohydrin/dimethylamine condensate, Hoffman-decomposed polyacrylamide, water-soluble polyester (Goo Chemical's Plas Coat Z-221, Z-446, Z-561, Z-450, Z-565, Z-850, Z-3308, RZ-105, RZ-570, Z-730, RZ-142) (all trade names).

In addition, as described in U.S. Pat. No. 4,960,681 and JP-A 62-245260, high-absorbent polymers, or that is, homopolymers of a vinyl monomer having —COOM or —SO₃M (M is a hydrogen atom or an alkali metal) or copolymers of the vinyl monomers or copolymers of the vinyl monomer with any other vinyl monomer (for example, sodium methacrylate, ammonium methacrylate, Sumitomo Chemical's Sumikagel L-5H (trade name) as the vinyl monomer) are also usable herein.

Of the water-soluble synthetic polymers usable in the invention, preferred are polyvinyl alcohols.

Polyvinyl alcohols are described in more detail hereunder.

As completely saponified polyvinyl alcohols, known are PVA-105 [polyvinyl alcohol (UVA) content, at least 94.0 mas.%; degree of saponification, 98.5±0.5 mol %; sodium acetate content, at most 1.5 mas.%; volatile content, at most 5.0 mas.%; viscosity, (4 mas.%, 20° C.), 5.6±0.4 CPS], PVA-110 [PVA content, 94.0 mas.%; degree of saponification, 98.5±0.5 mol %; sodium acetate content, 1.5 mas.%; volatile content, 5.0 mas.%; viscosity, (4 mas.%, 20° C.), 11.0±0.8 CPS], PVA-117 (PVA content, 94.0 mas.%; degree of saponification, 98.5±0.5 mol %; sodium acetate content, 1.0 mas.%; volatile content, 5.0 mas.%, viscosity, (4 mas.%, 20° C.), 28.0±3.0 CPS], PVA-117H [PVA content, 93.5 mas.%; degree of saponification, 99.5±0.3 mol %; sodium acetate content, 1.85 mas. %; volatile content, 5.0 mas.%; viscosity, (4 mas.%, 20° C.), 29.0±3.0 CPS], PVA-120 [PVA content, 94.0 mas.%; degree of saponification, 98.5±0.5 mol %; sodium acetate content, 1.0 mas.%; volatile content, 5.0 mas.%; viscosity, (4 mas.%, 20° C.), 39.5±4.5 CPS], PVA-124 [PVA content, 94.0 mas.%; degree of saponification, 98.5±0.5 mol %; sodium acetate content, 1.0 mas.%; volatile content, 5.0 mas.%; viscosity, (4 mas.%, 20° C.), 60.0±6.0 CPS], PVA-124H [PVA content, 93.5 mas.%; degree of saponification, 99.5±0.3 mol %; sodium acetate content, 1.85 mas.%; volatile content, 5.0 mas.%; viscosity, (4 mas.%, 20° C.), 61.0±6.0 CPS], PVA-CS [PVA content, 94.0 mas.%; degree of saponification, 97.5±0.5 mol %; sodium acetate content, 1.0 mas.%; volatile content, 5.0 mas.%; viscosity, (4 mas.%, 20° C.), 27.5±3.0 CPS], PVA-CST [PVA content, 94.0 mas.%; degree of saponification, 96.0±0.5 mol %; sodium acetate content, 1.0 mas.%; volatile content, 5.0 mas.%; viscosity, (4 mas.%, 20° C.), 27.0±3.0 CPS], PVA-HC [PVA content, 90.0 mas.%; degree of saponification, at least 99.85 mole; sodium acetate content, 2.5 mas.%; volatile content, 8.5 mas.%; viscosity, (4 mas.%, 20° C.), 25.0±3.5 CPS] (all trade names by Kuraray).

As partially saponified polyvinyl alcohols, known are PVA-203 [PVA content, 94.0 mas.%; degree of saponification, 88.0±1.5 mol %; sodium acetate content, 1.0 mas.%; volatile content, 5.0 mas.%; viscosity, (4 mas.%, 20° C.), 3.4±0.2 CPS], PVA-204 [PVA content, 94.0 mas.%; degree of saponification, 88.0±1.5 mol %; sodium acetate content, 1.0 mas.%; volatile content, 5.0 mas.%; viscosity, (4 mas.%, 20° C.), 3.9±0.3 CPS], PVA-205 [PVA content, 94.0 mas.%; degree of saponification, 88.0±1.5 mol %; sodium acetate content, 1.0 mas.%; volatile content, 5.0 mas.%; viscosity, (4 mas.%, 20° C.), 5.0±0.4 CPS], PVA-210 [PVA content, 94.0 mas.%; degree of saponification, 88.0±1.0 mol %; sodium acetate content, 1.0 mas.%; volatile content, 5.0 mas.%; viscosity, (4 mas.%, 20° C.), 9.0±1.0 CPS], PVA-217 [PVA content, 94.0 mas.%; degree of saponification, 88.0±1.0 mol %; sodium acetate content, 1.0 mas.%; volatile content, 5.0 mas.%; viscosity, (4 mas.%, 20° C.), 22.5±2.0 CPS], PVA-220 [PVA content, 94.0 mas.%; degree of saponification, 88.0±1.0 mol %; sodium acetate content 1.0 mas.%; volatile content, 5.0 mas.%; viscosity, (4 mas.%, 20° C.), 30.0±3.0 CPS], PVA-224 [PVA content, 94.0 mas.%; degree of saponification, 88.0±1.5 mol %; sodium acetate content, 1.0 mas.%; volatile content, 5.0 mas %; viscosity, (4 mas.%, 20° C.), 44.0±4.0 CPS], PVA-228 [PVA content, 94.0 mas.%; degree of saponification, 88.0±1.5 mol %; sodium acetate content, 1.0 mas.%; volatile content, 5.0 mas.%; viscosity, (4 mas.%, 20° C.), 65.0±5.0 CPS], PVA-235 [PVA content, 94.0 mas.%; degree of saponification, 88.0±1.5 mol %; sodium acetate content, 1.0 mas.%; volatile content, 5.0 mas.%; viscosity, (4 mas.%, 20° C.), 95.0±15.0 CPS], PVA-217EE [PVA content, 94.0 mas.%; degree of saponification, 88.0±1.0 mol %; sodium acetate content, 1.0 mas.%; volatile content, 5.0 mas.%; viscosity, (4 mas.%, 2000), 23.0±3.0 CPS], PVA-217E [PVA content, 94.0 mas.%; degree of saponification, 88.0±1.0 mol; sodium acetate content, 1.0 mas.%; volatile content, 5.0 mas.%; viscosity, (4 mas.%, 20° C.), 23.0±3.0 CPS], PVA-220E [PVA content, 94.0 mas.%; degree of saponification, 88.0±1.0 mol %; sodium acetate content, 1.0 mas.%; volatile content, 5.0 mas.%; viscosity, (4 mas.%, 20° C.), 31.0±4.0 CPS], PVA-224E [PVA content, 94.0 mas.%; degree of saponification, 88.0±1.0 mol %; sodium acetate content, 1.0 mas.%; volatile content, 5.0 mas.%; viscosity, (4 mas.%, 20° C.), 45.0±5.0 CPS], PVA-403 [PVA content, 94.0 mas.%; degree of saponification, 80.0±1.5 mol %; sodium acetate content, 1.0 mas.%; volatile content, 5.0 mas.%; viscosity, (4 mas.%, 20° C.), 3.1±0.3 CPS], PVA-405 [PVA content, 94.0 mas.%; degree of saponification, 81.5±1.5 mol %; sodium acetate content 1.0 mas.%; volatile content, 5.0 mas.%; viscosity, (4 mas.%, 20° C.), 4.8±0.4 CBS], PVA-420 [PVA content, 94.0 mas.%; degree of saponification, 79.5±1.5 mol %; sodium acetate content, 1.0 mas.%; volatile content, 5.0 mas.%], PVA-613 [PVA content, 94.0 mas.%; degree of saponification, 93.5±1.0 mol %; sodium acetate content, 1.0 mas.%; volatile content, 5.0 mas.%; viscosity, (4 mas.%, 20° C.), 16.5±2.0 CPS], L-8 [PVA content, 96.0 mas.%; degree of saponification, 71.0±1.5 mol %; sodium acetate content, 1.0 mas.% (ash); volatile content, 3.0 mas.%; viscosity, (4 mas.%, 20° C.), 5.4±0.4 CPS] (all trade names by Kuraray).

The above data were obtained according to JIS K-6726-1977.

Modified polyvinyl alcohols described in Koichi Nagano et al's “Poval” (issued by the Polymer Publishing) are usable herein. They are modified with cation, anion, —SH compound, alkylthio compound or silanol.

As modified polyvinyl alcohols (modified PVAs), available are C polymers such as C-118, C-318, C-318-2A, C-506 (all trade names by Kuraray); HL polymers such as HL-12E, HL-1203 (both trade names by Kuraray); HM polymers such as HM-03, HM-N-03 (both trade names by Kuraray); K polymers such as KL-118, KL-318, KL-506, KM-118T, KM-618 (all trade names by Kuraray); M polymers such as M-115 (trade name by Kuraray); MP polymers such as MP-102, MP-202, MP-203 (all trade named by Kuraray); MPK polymers such as MPK-1, MPK-2, MPK-3, MPK-4, MPK-5, MPK-6 (all trade names by Kuraray); R polymers such as R-1130, R-2105, R-2130 (all trade names by Kuraray); V polymers such as V-2250 (trade name by Kuraray).

Depending on minor solvents or inorganic salts to be added to its aqueous solution, polyvinyl alcohol makes it possible to control or stabilize its viscosity; and precisely, those described in the above-mentioned reference, Koichi Nagano et al's “Poval” issued by the Polymer Publishing, pp. 144-154 can be used. As one typical example, boric acid is preferably added to the polymer so as to improve the coating surface quality. The amount of boric acid to be added is preferably from 0.01 to 40% by mass relative to polyvinyl alcohol.

The polymer latex for use in the invention acts to receive the dye transferred from an ink sheet, and the polymer latex may be combined with any polymer.

The polymer that may be combined may act to receive dye, but may also serve as a binder that holds the polymer latex. The polymer is preferably transparent or semitransparent and generally colorless, including natural resins, polymers and copolymers, and synthetic resins, polymers and copolymers, and other film-forming media, for example, rubbers, polyvinyl alcohols, hydroxyethyl celluloses, cellulose acetates, cellulose acetate butyrates, polyvinylpyrrolidones, starch, polyacrylic acids, polymethyl methacrylates, polyvinyl chlorides, polymethacrylic acids, styrene-maleic anhydride copolymers, styrene-acrylonitrile copolymers, styrene-butadiene copolymers, polyvinyl acetals (e.g., polyvinyl formal, polyvinyl butyral), polyesters, polyurethanes, phenoxy resins, polyvinylidene chlorides, polyepoxides, polycarbonates, polyvinyl acetates, polyolefins, cellulose esters, polyamides. The binder may be formed from water or from an organic solvent or an emulsion by coating.

In the invention, the water-soluble polymer is preferably polyvinyl alcohols, gelatin, most preferably gelatin.

The amount of the water-soluble polymer in the receiving layer is preferably from 1 to 25% by mass of all the receiving layer, more preferably from 1 to 10% by mass. Not using a water-soluble polymer is one preferred embodiment of the invention.

The polymers other than water-soluble polymer which are to be used for the binder for use in the invention may be readily obtained through solution polymerization, suspension polymerization, emulsion polymerization, dispersion polymerization, anionic polymerization, cationic polymerization, etc. Most preferred is emulsion polymerization capable of giving the polymer as a latex. Also preferred is a method of preparing a polymer in a solution, then adding water thereto after neutralization or after adding an emulsifier thereto, and forcedly stirring it to prepare an aqueous dispersion. The emulsion polymerization method may be attained, for example, as follows: Water, or a mixed solvent of water and a water-miscible organic solvent (e.g., methanol, ethanol, acetone) is used as a dispersion medium, and a monomer mixture in an amount of from 5 to 150% by mass relative to the dispersion medium and an emulsifier and a polymerization relative to the total monomer amount are used, and the system is polymerized with stirring at 30 to 100° C. or so, preferably at 60 to 90° C. for 3 to 24 hours. The conditions of the dispersion medium, the monomer concentration, the amount of initiator, the amount of emulsifier, the amount of dispersant, the reaction temperature and the mode of monomer addition may be suitably determined in consideration of the type of the monomer to be used. If desired, a dispersant is preferably used.

The emulsion polymerization method may be generally attained according to the following literature. Taira Okuda & Hiroshi Inagaki, “Synthetic Resin Emulsion”, issued by the Polymer Publishing, 1978; Takaaki Sugimura, Yasuo Kataoka, Soichi Suzuki, & Keiji Kasahara, “Applications of Synthetic Latex”, issued by the Polymer Publishing, 1993; Soichi Muroi, “Chemistry of Synthetic Latex”, issued by the Polymer Publishing, 1970. For the emulsion polymerization method for producing the polymer latex for use in the invention, any of a batch polymerization method, a monomer (continuous, intermittent) addition method, an emulsion addition method, a seed polymerization method may be selected. From the viewpoint of latex producibility, preferred are a batch polymerization method, a monomer (continuous, intermittent) addition method, an emulsion addition method.

The polymerization initiator may be any one having a radical-generating capability. For it, for example, usable are inorganic peroxides such as persulfates, hydrogen peroxide; peroxides described in Nippon Yushi's “Catalog of Organic Peroxides”; and azo compounds described in Wako Pure Chemical Industry's “Catalog of Azo Polymerization Initiators”. Of those, preferred are water-soluble peroxides such as persulfates, and water-soluble azo compounds described in Wake Pure Chemical Industry's “Catalog of Azo Polymerization Initiators”; more preferred are ammonium persulfate, sodium persulfate, potassium persulfate, azobis(2-methylpropionamidine) hydrochloride, azobis(2-methyl-N-(2-hydroxyethyl)propionamide), azobiscyanovaleric acid; and even more preferred are peroxides such as ammonium persulfate, sodium persulfate, potassium persulfate, from the viewpoint of the image storability, the solubility and the cost.

The amount of the polymerization initiator to be added is preferably from 0.3% by mass to 2.0% by mass relative to the total monomer amount, more preferably from 0.4% by mass to 1.75% by mass, even more preferably from 0.5% by mass to 1.5% by mass.

For the polymerization emulsifier, employable is any of anionic surfactants, nonionic surfactants, cationic surfactants, ampholytic surfactants. Preferred are anionic surfactants from the viewpoint of the dispersibility and the image storability. More preferred is a sulfonic acid-type anionic surfactant, as it ensures polymerization stability even though its amount is small, and as it has hydrolysis resistance. Even more preferred is a long-chain alkyldiphenyl ether disulfonate such as typically Pelex SS-H (trade name by Hao); and still more preferred is a low-electrolyte type surfactant such as Pionine A-43-S (trade name by Takemoto Yushi).

Preferably, as the polymerization emulsifier, a sulfonic acid-type anionic surfactant is used in an amount of from 0.1% by mass to 10.0% by mass relative to the total monomer amount, more preferably from 0.2% by mass to 7.5% by mass, even more preferably from 0.3% by mass to 5.0% by mass.

For producing the polymer latex for use in the invention, preferably used is a chelating agent. The chelating agent is a compound capable of coordinating (chelating) a polyvalent ion, for example a metal ion such as iron ion or an alkaline earth metal ion such as calcium ion; and for it, usable are the compounds described in the published official gazettes or the specifications of JP-B 6-8956, U.S. Pat. No. 5,053,322, JP-A 4-73645, 4-127145, 4-247073, 4-305572, 6-11805, 5-173312, 5-66527, 5-158195, 6-118580, 6-110168r 6-161054, 6-175299, 6-214352, 7-114161, 7-114154, 7-120894, 7-199433, 7-306504, 9-43792, 8-314090, 10-182571, 10-182570, 11-190892.

For the chelating agent, preferred are inorganic chelating compounds (e.g., sodium tripolyphosphate, sodium hexametaphosphate, sodium tetrapolyphosphate), aminopolycarboxylic acid-type chelating compounds (e.g., nitrilotriacetic acid, ethylenediaminetetraacetic acid), organic phosphonic acid-type chelating agents (as in Research Disclosure No. 18170, JP-A 52-102726, 53-42730, 56-97347, 54-121127, 55-4024, 55-4025, 55-29883, 55-126241, 55-65955, 55-65956, 57-179843, 54-61125, German Patent 1045373) polyphenol-type chelating agents, polyamine-type chelating compounds; and more preferred are aminopolycarboxylic acid derivatives.

Preferred examples of the aminopolycarboxylic acid derivatives are the compounds given in the attached table of “EDTA(-Chemistry of Complexanes-)” (by Nanko-do, 1977); and the carboxyl group in these compounds may be partly substituted with an alkali metal salt such as sodium or potassium or an ammonium salt. Especially preferred aminocarboxylic acid derivatives are iminodiacetic acid, N-methyliminodiacetic: acid, N-(2-aminoethyl)iminodiacetic acid, N-(carbamoylmethyl)iminodiacetic acid, nitrilotriacetic acid, ethylenediamine-N,N′-diacetic acid, ethylenediamine-N,N′-di-α-propionic acid, ethylenediamine-N,N′-di-E-propionic acid, N,N′-ethylene-bis(α-o-hydroxyphenyl)glycine, N,N′-di(2-hydroxybenzyl)ethylenediamine-N,N′-diacetic acid, ethylenediamine-N,N′-diacetic acid-N,N′-diacetohydroxamic acid, N-hydroxyethylethylenediamine-N,N′,N′-triacetic acid, ethylenediamine-N,N,N′,N′-tetraacetic acid, 1,2-propylenediamine-N,N,N′,N′-tetraacetic acid, d,l-2,3-diaminobutane-N,N,N′,N′-tetraacetic acid, meso-2,3-diaminobutane-N,N,N′,N′-tetraacetic acid, 1-phenylethylenediamine-N,N,N′,N′-tetraacetic acid, d,l-1,2-diphenylethylenediamine-N,N,N′,N′-tetraacetic acid, 1,4-diaminobutane-N,N,N′,N′-tetraacetic acid, trans-cyclobutane-1,2-diamine-N,N,N′,N′-tetraacetic acid, trans-cyclopentane-1,2-diamine-N,N,N′,N′-tetraacetic acid, trans-cyclohexane-1,2-diamine-N,N,N′,N′-tetraacetic acid, cis-cyclohexane-1,2-diamine-N,N,N′-N′-tetraacetic acid, cyclohexane-1,3-diamine-N,N,N′,N′-tetraacetic acid, cyclohexane-1,4-diamine-N,N,N′,N′-tetraacetic acid, o-phenylenediamine-N,N,N′,N′-tetraacetic acid, cis-1,4-diaminobutene-N,N,N′,N′-tetraacetic acid, trans-1,4-diaminobutene-N,N,N′,N′-tetraacetic acid, α,α′-diamino-o-xylene-N,N,N′,N′-tetraacetic acid, 2-hydroxy-1,3-propanediamine-N,N,N,N′-tetraacetic acid, 2,2′-oxy-bis(ethyliminodiacetic acid), 2,2′-ethylenedioxy-bis(ethyliminodiacetic acid), ethylenediamine-N,N′-diacetic acid-N,N′-di-α-propionic acid, ethylenediamine-N,N′-diacetic acid-N,N′-di-β-propionic acid, ethylenediamine-N,N,N′,N′-tetrapropionic acid, diethylenetriamine-N,N,N′,N″,N″-pentaacetic acid, triethylenetetramine-N,N,N′,N″,N′″,N′″-hexaacetic acid, 1,2,3-triaminopropane-N,N,N′,N″,N′″,N′″-hexaacetic acid; and the carboxyl group in these compounds may be partly substituted with an alkali metal salt such as sodium or potassium or an ammonium salt.

The amount of the chelating agent to be added is preferably from 0.01% by mass to 0-4% by mass relative to the total monomer amount; preferably from 0.02% by mass to 0.3% by mass, more preferably from 0.03% by mass to 0.15% by mass. When the amount of the chelating agent is less than 0.01% by mass, then the trapping of the metal ion with which the polymer latex may be contaminated in its production process would be insufficient, and the latex stability against coagulation may lower, and the coatability of the composition may be worsened. When the amount is more than 0.4% by mass, then the latex viscosity may increase to worsen the coatability.

In producing the polymer latex for use in the invention, preferably used is a chain transfer agent. The chain transfer agent is preferably those described in “Polymer Handbook, 3rd Ed.” (by Wiley-Interscience, 1989). Sulfur compounds are more preferred as having a high chain transfer capability, and the amount thereof to be used may be small. Especially preferred is a hydrophobic mercaptan-type chain transfer agent such as tert-dodecylmercaptan, n-dodecylmercaptan.

The amount of the chain transfer agent to be used is preferably from 0.2w by mass to 2.0% by mass, more preferably from 0.3% by mass to 1.8% by mass, even more preferably from 0.4% by mass to 1.6% by mass.

In the emulsion polymerization, further usable are various additives as described in Synthetic Rubber Handbook, for example, electrolyte, stabilizer, thickener, defoaming agent, antioxidant, vulcanizing agent, freezing inhibitor, gelling agent, vulcanization promoter and others, in addition to the above-mentioned compounds.

As the solvent for the coating liquid of the polymer latex for use in the invention, a water-base solvent may be used, and it may be combined with a water-miscible organic solvent. The water-miscible organic solvent includes, for example, alcohol solvents such as methyl alcohol, ethyl alcohol, propyl alcohol; cellosolve solvents such as methyl cellosolve, ethyl cellosolve, butyl cellosolve; and ethyl acetate, dimethylformamide, etc. The amount of the organic solvent to be added is preferably at most 50% by mass of the solvent, more preferably at most 30% by mass.

The polymer concentration in the polymer latex for use in the invention is preferably from 10 to 70% by mass relative to the latex liquid, more preferably from 20 to 60% by mass, even more preferably from 30 to 55% by mass.

The amount of the polymer latex to be added is preferably from 50 to 95% by mass, in terms of the solid content of the polymer latex, of all the polymer in the receiving layer, more preferably from 70 to 90% by mass.

The polymer latex in the thermal transfer image-receiving sheet of the invention includes a gel or a dry film formed by drying away a part of the solvent after coating.

### <UV Absorbent>

The receiving layer may contain a UV absorbent for improving the light fastness thereof. In this, when a polymer UV absorbent is used, it may be fixed to the receiving layer, and may be prevented from diffusing into ink sheet and from subliming and evaporating under heat.

As the UV absorbent, usable are various UV absorbent skeleton-having compounds widely well known in the field of information recording. Concretely, there are mentioned compounds having a skeleton of 2-hydroxybenzotriazole-type UV absorbents, 2-hydroxybenzotriazine-type UV absorbents or 2-hydroxybenzophenone-type UV absorbents. From the viewpoint of the UV absorption capability (absorbent coefficient) and the stability, preferred are compounds having a benzotriazole or triazine skeleton; and from the viewpoint of forming them into polymer or latex, preferred are compounds having a benzotriazole or benzophenone skeleton. Concretely, the UV absorbents described in JP-A 2004-361936 may be used herein.

Preferably, the UV absorbent has an absorption in the UV range and its absorption edges do not step in the visible range. Concretely, when a UV absorbent is added to a receiving layer in producing a thermal transfer image-receiving sheet, it is desirable that the reflection density at 370 nm is Abs 0.5 or more; more preferably the reflection density at 380 nm is Abs 0.5 or more. Also preferably, the reflection density at 400 nm is Abs 0.1 or less. In case where the reflection density within a range over 400 nm is high, it is undesirable since the formed image may yellow.

Preferably in the invention, the UV absorbent to be used is in the form of a polymer preferably having a weight-average molecular weight of at least 10000; more preferably at least 100000. For producing a polymer UV absorbent, preferably employed is a method of grafting a polymer with a UV absorbent. Preferably, the polymer to be the main chain of the polymer UV absorbent has a polymer skeleton of which the dye fixability is poorer than that of the receiving polymer to be combined with it. Also preferably, the polymer film has a sufficient film strength. The grafting ratio of the UV absorbent to the polymer main chain is preferably from 5 to 20% by mass, more preferably from 8 to 15% by mass.

Further preferably, the UV absorbent-grafted polymer is formed into a latex. The polymer UV absorbent latex may be in a water-base coating dispersion that may be formed into a receiving layer by film formation by coating, and therefore it may reduce the production cost. For the latex formation, for example, employable is the method described in Japanese Patent 3450339. The UV absorbent latex is commercially available, for example, as Ipposha Yushi Kogyo's ULS-7(0, ULS-1700, ULS-1383MA, ULS-1635 MH, XL-7016, ULS-933LP, ULS-935LH; Shin-Nakamura Chemical's New Coat UVA-1025W, New Coat UVA-204W, New Coat UVA-4512M (all trade names).

When a UV absorbent-grafted polymer is formed into a latex, it may be mixed with a latex of the above-mentioned dye-fixable receiving polymer, and the resulting mixture may be applied onto a support. Accordingly, a receiving layer with a UV absorbent uniformly dispersed therein may be formed.

The amount of the UV absorbent-grafted polymer or its latex to be added is preferably from 5 to 50 parts by mass relative to the dye-fixable receiving polymer latex that forms the receiving layer, more preferably from 10 to 30 parts by mass.

### <Lubricant>

The receiving layer may contain a lubricant for preventing thermal fusion with a thermal transfer sheet in image formation. For the lubricant, usable are silicone oil, phosphate plasticizers, fluorine compounds and wax dispersion. Especially preferred are silicone oil and wax dispersion.

As the silicone oil, preferably used is a modified silicone oil, such as epoxy-modified, alkyl-modified, amino-modified, carboxyl-modified, alcohol-modified, fluorine-modified, alkylaralkyl-polyether-modified, epoxy-polyether-modified or polyether-modified one. Above all, preferred is a reaction product of a vinyl-modified silicone oil and a hydrogen-modified silicone oil. The amount of the lubricant to be added is preferably from 0.2 to 30 parts by mass relative to the receiving polymer.

As the wax dispersion, usable is any known dispersion. In the invention, “wax”; means a alkyl chain-having organic substance that is solid or semisolid at room temperature (according to the definition given in “Revised Edition, Properties and Applications of Wax” (Miyuki Publishing, 1989)). Preferred examples of the compounds are candelilla wax, carnauba wax, rice wax, haze wax, montan wax, ozocerite, paraffin wax, microcrystalline wax, petrolatum, Fisher-Tropsch wax, polyethylene wax, montan wax derivatives, paraffin wax derivatives, microcrystalline wax derivatives, hardened caster oil, hardened castor oil derivatives, 12-hydroxystearic acid, stearylamide, phthalic anhydride imide, chlorohydrocarbons, and other compound waxes. Of those, preferred are carnauba wax, montan wax and its derivatives, paraffin wax and its derivatives, microcrystalline was and its derivatives, polyethylene wax, stearylamide; more preferred are carnauba wax, montan wax and its derivatives, microcrystalline wax, stearylamide; even more preferred are montan wax and its derivatives, microcrystalline wax.

The wax is selected from those having a melting point of from 25° C. to 120° C., more preferably from 40° C. to 100° C., even more preferably from 60° C. to 90° C.

### <Emulsion>

Hydrophobic additives such as lubricant and antioxidant may be incorporated into the layers (e.g., receiving layer, heat-insulating layer, interlayer, undercoat layer) of the image-receiving sheet in any known method, for example, according to the method described in U.S. Pat. No. 2,322,027. In this case, a high-boiling-point organic solvent as in U.S. Pat. No. 4,555,470, U.S. Pat. No. 4,536,466, U.S. Pat. No. 4,536,467, U.S. Pat. No. 4,587,206, U.S. Pat. No. 4,555,476, U.S. Pat. No. 4,599,296, JP-B 3-62256 may be used optionally along with a low-boiling-point organic solvent having a boiling point of from 50° C. to 160° C. Two or more different types of those lubricants, antioxidants and high-boiling-point organic solvent may be used, as combined.

The lubricant includes, for example, solid waxes such as polyethylene wax, amide wax, Teflon powder; as well as silicone oils, phosphate compounds, fluorine-containing surfactants, silicone-type surfactants and any other lubricants known in the art. Preferred are various waxes; fluorine compounds such as typically fluorine-containing surfactants; and silicone compounds such as silicone-type surfactants, silicone oils and/or their cured products.

### <Surfactant>

In the thermal transfer image-receiving sheet of the invention, a surfactant may be incorporated in any layers mentioned above. Preferably, it is incorporated into the receiving layer and the interlayer of the sheet.

The amount of the surfactant to be added is preferably from 0.01 to 5% by mass relative to the overall solid content of the layer, more preferably from 0.01 to 1% by mass, even more preferably from 0.02 to 0.2% by mass.

As the surfactant, known are various surfactants such as anionic, nonionic and cationic surfactants. In the invention, any known surfactant is usable, and for example; those introduced in “Functional Surfactants”, by Mitsuo Kakuta, August 2000, Chap. 6 may be used. Of those, preferred are anionic fluorine-containing surfactants.

Even though the coating liquid does not contain a surfactant, it may be used for coating in the invention. However, since the surface tension of the coating liquid is high and the coating surface may be roughened and may be uneven. Adding a surfactant to the coating liquid lowers the surface tension, whereby the coating unevenness may be evaded and the coating surface may be uniform, and the coating operation may be attained stably.

Specific examples of the fluorine compounds are shown below; however, the fluorine compounds usable in the invention should not be limited to the following examples. Unless otherwise specifically indicated, the alkyl group and the perfluoroalkyl group in the structures of the following compounds have a linear chain structure.

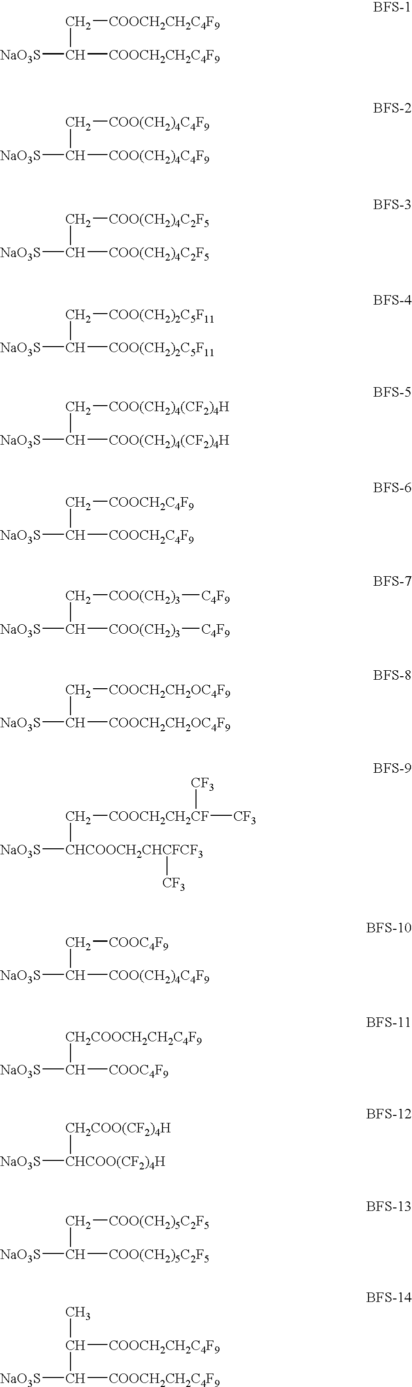

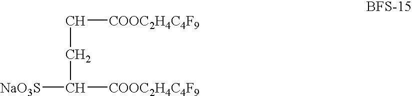

These fluorine compounds are used, as a surfactant, in a coating composition for forming a layer that constitutes the thermal transfer image-receiving sheet of the invention (especially, receiving layer, heat-insulating layer, interlayer, undercoat layer, back layer); preferably in the invention, they may be incorporated in the receiving layer and the interlayer of the sheet.

### <Hardener>

The hardener used as a crosslinking agent in the invention may be added to the coating layers (e.g., receiving layer, heat-insulating layer, undercoat layer) of the image-receiving sheet.

As the hardener usable in the invention, preferred are H-1, 4, 6, 8, 14 on page 17 of JP-A 1-214845; compounds (H-1 to 54) of formulae (VII) to (XII) in columns 13-23 of U.S. Pat. No. 4,619,573; compounds (H-1 to 76) of the right lower formula (6) on page 8 of JP-A 2-214852, especially H-14; and compounds described in claim 1 of U.S. Pat. No. 3,325,287. As examples of the hardener, there are mentioned those described in U.S. Pat. No. 4,678,739, column 41; U.S. Pat. No. 4,791,042; JP-A 59-116655, 62-245261, 61-18942, 4-218044. More concretely, they include aldehyde-type hardeners (formaldehyde, etc.), aziridine-type hardeners, epoxy-type hardeners, vinyl sulfone-type hardeners (N,N′-ethylene-bis(vinylsulfonylacetamido)ethane, etc.), N-methylol-type hardeners (dimethylolurea, etc.), boric acid, metaboric acid and polymer hardeners (compounds descried in JP-A 62-234157, etc.).

Preferred are vinyl sulfone-type hardeners and chlorotriazines.

More preferred hardeners for use in the invention are compounds of the following general formula (B) or (C):

(CH₂═CH—SO₂)n-L (B)

(X—CH₂—CH₂—SO₂)n-L (C)

In formulae (B) and (C), X represents a halogen atom, L represents an n-valent organic linking group. In case where the compounds of formula (B) or (C) are low-molecular compounds, n indicates an integer of from 1 to 4. When they are high-molecular compounds, L is a polymer chain-containing organic linking group, and in this case, n is within a range of from 10 to 1000.

In formulae (B) and (C), X is preferably a chlorine atom or a bromine atom, more preferably a bromine atom. n is an integer of from 1 to 4, but is preferably an integer of from 2 to 4, more preferably an integer of 2 or 3, most preferably 2.

L represents an n-valent organic group, preferably an aliphatic hydrocarbon group, an aromatic hydrocarbon group or a heterocyclic group; and these groups may bond to each other via an ether bond, an ester bond, an amide bond, a sulfonamide bond, an urea bond, an urethane bond or the like. These groups may have a substituent including, for example, a halogen atom, an alkyl group, an aryl group, a heterocyclic group, a hydroxyl group, an alkoxy group, an aryloxy group, an alkylthio group, an arylthio group, an acyloxy group, an alkoxycarbonyl group, a carbamoyloxy group, an acyl group, an acyloxy group, an acylamino group, a sulfonamide group, a carbamoyl group, a sulfamoyl group, a sulfonyl group, a phosphoryl group, a carboxyl group, a sulfo group. Preferred are a halogen atom, an alkyl group, a hydroxyl group, an alkoxy group, an aryloxy group and an acyloxy group.

The hardener may be used in an amount of from 0.001 to 1 g per gram of the water-soluble polymer, preferably from 0.005 to 0.5 g.

### <Preservative>

When the coating liquid, the image-receiving sheet and the print image are stored, then microorganisms (especially bacteria, fungi, yeasts) may adhere to the materials, thereby often worsen their properties. For preventing it, a preservative may be added to the material within a range not having any influence on the other properties of the materials.

The preservative as referred to herein is a compound used for preventing the compounds used in the image-receiving sheet from being degraded by the growth of microorganisms; and its definition by a general formula and its concrete examples are described in “Preservative Antifungal Handbook”, published by Gihodo (1986), written by Hiroshi Horiguchi; “Chemistry of Antibacterial and Antifungal”, published by Sankyo Publishing (1986); “Encyclopedia of Antibacterial and Antifungal Agent”, published by the Antibacterial and Antifungal Society of Japan (1986).

Not specifically defined, the preservative that may be in the thermal transfer image-receiving sheet of the invention includes phenol or its derivatives, formalin, imidazole derivatives, sodium dehydroacetate, 4-isothiazolin-3-one derivatives, benzisothiazolin-3-one, benzotriazole derivatives, amidine-guanine derivatives, quaternary ammonium salts, derivatives of pyrrolidine, quinoline, guanidine and the like, diazine, triazole derivatives, oxazole, oxazine derivatives, 2-mercaptopyridine-N-oxide or its salts, formaldehyde donor-type microbicides. Of those, preferred are phenol or its derivatives, 4-isothiazolin-3-one derivatives, benzoisothiazolin-3-one.

In addition to the above, compounds of the following general formulae [I] to [IV] are also usable as preservative.

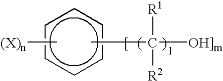

In formula [I], R¹ and R² may be the same or different, each representing a hydrogen atom, a hydroxyl group or a lower alkyl group. X represents a hydrogen atom, a halogen atom, a nitro group, a cyano group, an aryl group, a lower alkyl group, a lower alkenyl group, an aralkyl group, an alkoxy group, —COR³, —SO₂R⁴ or N(R⁵)R⁶; R³ and R⁴ may be the same or different, each representing a hydrogen atom, —OM, a lower alkyl group, a lower alkoxy group or N(R⁷)R⁸.

R⁵ and R⁶ may be the same or different, each representing a hydrogen atom, a lower alkyl group, —COR⁹ or SO₂R¹⁰. R⁹ and R¹⁰ may be the same or different, each representing a lower alkyl group or N(R¹¹) R¹²; R⁷, R⁸, R¹¹ and R¹² may be the same or different, each representing a hydrogen atom or a lower alkyl group.

M represents a hydrogen atom, an alkali metal atom, or an atomic group necessary for forming a monovalent cation; 1 indicates an integer of from 2 to 6; m indicates an integer of from 1 to 4; n is (6-m). However, when the formula has plural R¹'s, R²'s and X's, then they may be the same or different.

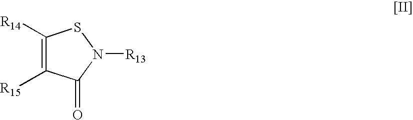

In formula [II], R¹³ represents a hydrogen atom, an alkyl group, an alkenyl group, an aralkyl group, an aryl group, a heterocyclic group,

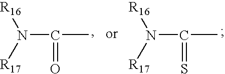

R¹⁴ and R¹⁵ may be the same or different, each representing a hydrogen atom, an alkyl group, an aryl group, a cyano group, a heterocyclic group, a halogen atom, a hydroxyl group, a sulfo group, an amino group, an alkylamino group, an acylamino group, an alkoxycarbonylamino group, an alkylthio group, an alkylsulfoxy group, or an alkylsulfonyl group; R¹⁴ and R¹⁵ may bond to each other to form an aromatic ring.

R¹⁶ and R¹⁷ may be the same or different, each representing a hydrogen atom, an alkyl group, an aryl group, or an aralkyl group.

Of those, preferred are compounds where R¹⁴ and R¹⁵ are hydrogen atoms, and R¹³ is a methyl group (hereinafter referred to as compounds II-a). More preferred are a combination of a compound where R¹⁴ and R¹⁵ bond to each other to form an aromatic ring and R¹³ is a hydrogen atom and the compound (II-a); and a combination of a compound where R¹⁴ is a chlorine atom, R¹⁵ is a hydrogen atom and R¹³ is a methyl group, and the compound (II-a).

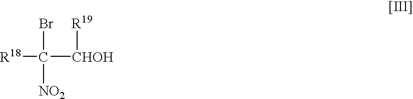

In formula [III], R¹⁸ represents a hydrogen atom, an alkyl group, or a hydroxymethyl group; R¹⁹ represents a hydrogen atom or an alkyl group.

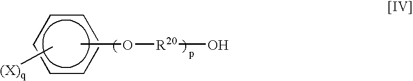

In formula [IV], R²⁰ represents a lower alkylene group; X represents a hydrogen atom, a halogen atom, a nitro group, a hydroxyl group, a cyano group, a lower alkyl group, a lower alkoxy group, —COR²¹, —N(R²²)R²³ or —SO₃M; R represents a hydrogen atom, —OM, a lower alkyl group, an aryl group, an aralkyl group, a lower alkoxy group, an aryloxy group, an aralkyloxy group or —N(R²⁴)R²⁵.

R²² and R²³ may be the same or different, each representing a hydrogen atom, a lower alkyl group, an aryl group, an aralkyl group, —COR²⁶ or —SO₂R²⁶; R²⁴ and R²⁵ may be the same or different, each representing a hydrogen atom, a lower alkyl group, an aryl group, or an aralkyl group; R²⁶ represents a lower alkyl group, an aryl group or an aralkyl group; M represents a hydrogen atom, an alkali metal atom, or an atomic group necessary for forming a monovalent cation; p indicates 0 or 1; q indicates an integer of from 0 to 5.

One preservative may be used singly, or two or more different types of compounds may be selected and combined for the preservative. The preservative may be directly added as it is, but may be dissolved in water or an organic solvent such as methanol, ethanol, isopropyl alcohol, acetone, ethylene or ethylene glycol, and the solution may be added to the coating liquid for the image-receiving sheet. If desired, it may be added to latex. As the case may be, the preservative may be dissolved in a high-boiling-point solvent, a low-boiling-point solvent, or a mixed solvent of the two, and then emulsified and dispersed in the presence of a surfactant, and may be added to latex.

### <Mat Agent>

Preferably in the invention, a mat agent is added to the sheet for imparting lubricity thereto. Preferably, the mat agent is added to the outermost surface layer or the layer functioning as an outermost surface layer of the thermal transfer image-receiving sheet, or to a layer nearer to the outer surface of the sheet. If desired, the outermost surface layer may have a two-layered structure. Most preferably, the mat agent is added to the outermost receiving layer. The mat agent may be added either to the outermost layer on the side of the image-forming layer or to the outermost layer on the back side, or may be added to both the two. In particular, the mat agent is preferably added to the surface containing a lubricant on the side of the sheet opposite to the support.

Preferably, the mat agent is dispersed with a binder, and is used as a mat agent particle dispersion.

As the mat agent, generally used are particles of water-insoluble organic compound or particles of inorganic Compound. In the invention, preferred are particles containing an organic compound from the viewpoint of their dispersibility. The particles may be any ones containing an organic compound, or that is, they may be particles of an organic compound alone, or may be organic/inorganic composite particles containing not only an organic compound but also an inorganic compound. Examples of the mat agent are, for example, organic mat agents described in U.S. Pat. No. 1,939,213, U.S. Pat. No. 2,701,245, U.S. Pat. No. 2,322,037, U.S. Pat. No. 3,262,782, U.S. Pat. No. 3,539,344, U.S. Pat. No. 3,767,448; and any ones well known in the field of silver salt photographic materials are usable herein.

In image printing, the surface of the receiving layer is heated high, and therefore, it is desirable that the mat agent is resistant to heat.

In particular, the agent is a polymer having a thermal decomposition temperature of not lower than 200° C., more preferably a thermal decomposition temperature of not lower than 240° C.

In image printing, in addition, not only heat but also pressure is given to the surface of the receiving layer. Therefore, the mat agent is preferably hard.

The mat agent to be in the outermost layer or the adjacent layer to the outermost layer on the side of the image-forming layer is, after previously dispersed with a binder, used as a mat agent particle dispersion. The method for dispersion includes two methods, a method (a) where a polymer to be the mat agent is formed into its solution (for example, by dissolving it in a low-boiling-point organic solvent), then it is emulsified and dispersed in an aqueous medium to give polymer liquid droplets, and the low-boiling-point organic solvent is removed from the emulsion, thereby preparing a mat agent dispersion; and a method (b) where particles of a polymer to be the mat agent are previously prepared, and they are dispersed in an aqueous medium with preventing them from forming lumps, thereby preparing a mat agent dispersion. In the invention, the method (b) is preferred not discharging a low-boiling-pint organic solvent in the environment, in consideration of the environmental protection.

The dispersed state of the mat agent particle dispersion in the invention may be more stable when it contains a surfactant, and therefore, a surfactant is preferably added to the dispersion.

### (Heat-Insulating Layer)

The heat-insulating layer plays a role of protecting the support from heat in thermal transfer with thermal head. In addition, since the layer is highly cushionable, the thermal transfer image-receiving sheet having the layer may have high printing sensitivity even when its support is formed of paper. The heat-insulating layer may be one layer or two layers. The heat-insulating layer may be provided nearer to the support than the image-receiving layer.

In the thermal transfer image-receiving sheet of the invention, the heat-insulating layer is preferably formed by water-base coating, and more preferably contains a hollow polymer.

The hollow polymer as referred to in the invention is polymer particles having closed pores inside the particles, and is preferably a polymer latex. For examples it includes (1) non-foamed hollow particles of polystyrene, acrylic resin, styrene-acrylic resin or the like, in which water exists inside the area surrounded by partition walls, and which are such that, after applied onto a support and dried thereon, the water inside the particles evaporates and the particles therefore become hollow, (2) foamed microballoons produced by coating a low-boiling point liquid such as butane, pentane or the like with a resin of any of polyvinylidene chloride, polyacrylonitrile, polyacrylic acid, polyacrylate or their mixture or polymer, which are such that, after applied onto a support and heated thereon, the low-boiling-point liquid inside the particles expands to make the particles hollow, and (3) microballoons produced by previously heating and foaming the above (2) to give a hollow polymer.

Preferably, the mean particle size of the hollow polymer is from 0.3 to 1.0 μm. If the size is too small, then the porosity may lower and the hollow polymer could not exhibit the desired heat insulating capability; but if too large, the frequency of troubles of surface condition owing to the coarse particles of the heat-insulating layer may increase.

Also preferably, the hollow polymer has a porosity of from 20 to 70% or so, more preferably from 20 to 50%. If the porosity is too small, then the hollow polymer could not exhibit the desired heat insulating capability; but if too large, the number of the brittle hollow polymer particles and incomplete hollow polymer particles may increase, thereby causing print failures, and in addition, the film strength may be poor.

If desired, two or more different types of such hollow polymers may be combined and used herein. Concrete examples of the above (1) are Rohm & Haas' Lowpake 1055, Dai-Nippon Ink's Boncoat PP-1000, JSR's SXB66(B), Nippon Zeon's Nippol MH5055 (all trade names). Examples of the above (2) are Matsumoto Yushi Seiyakuls F-30, F-50 (both trade names). Examples of (3) are Matsumoto Yushi Seiyaku's F-30E, Nippon Ferrite's Expancel 461DE, 551DE, 551DE20 (all trade names). The hollow polymer for use in the heat-insulating layer may be in the form of latex.

Not specifically defined, the glass transition temperature (Tg) of the hollow polymer is preferably not lower than 70° C., more preferably not lower than 100° C. If desired, two or more different types of hollow polymers may be used herein, as combined.

The heat-insulating layer that contains the hollow polymer preferably contains a water-dispersible resin or a water-soluble resin as a binder resin, in addition to the hollow polymer. The binder resin for use in the invention may be any known resin including acrylic resin, styrene-acryl copolymer, polystyrene resin, polyvinyl alcohol resin, vinyl acetate resin, ethylene-vinyl acetate copolymer, vinyl chloride-vinyl acetate copolymer, styrene-butadiene copolymer, urethane resin, polyvinylidene chloride resin, cellulose derivative, casein, starch, gelatin. Preferred are the water-soluble polymers described in the above for the receiving layer. Of those binder resins, preferred are gelatin, polyvinyl alcohol, styrene-butadiene copolymer, urethane resin; and more preferred are gelatin, polyvinyl alcohol. One or more these resins may be used, either singly or as combined.

The solid content of the hollow polymer in the heat-insulating layer is preferably from 5 to 2000 parts by mass relative to 100 parts by mass of the solid content of the binder resin therein. The ratio by mass of the solid content of the hollow polymer to be in the coating liquid is preferably from 1 to 70% by mass, more preferably from 10 to 40% by mass. When the ratio of the hollow polymer is too small, then it could not give sufficient heat insulation; but if too large, the binding force of the hollow polymer to each other may lower, therefore causing problems of powder dropping or film peeling during treatment.

The particle size of the hollow polymer is preferably from 0.1 to 20 μm, more preferably from 0.1 to 2 μm, even more preferably from 0.1 to 1 μm.

The amount of the binder to be in the coating liquid for heat-insulating layer is preferably from 0.5 to 14% by mass, more preferably from 1 to 6% by mass. The coating amount of the hollow polymer in the heat-insulating layer is preferably from 1 to 100 g/m², more preferably from 5 to 20 g/m².

Preferably, the thickness of the hollow polymer-containing heat-insulating layer is from 5 to 50 μm, more preferably from 5 to 40 μm.

### (Interlayer)

An interlayer may be formed between the receiving layer and the support. For example, a white background-controlling layer, a static charge-controlling layer, an adhesive layer, a primer layer, an undercoat layer may be formed. These layers may have the same structures as in Japanese Patents 3585599, 2925244.

### (Support)

In the invention, the support is preferably a waterproof support. The waterproof support may prevent the support from absorbing water and therefore may prevent the receiving layer from being deteriorated with time. The waterproof support is, for example, coated paper or laminate paper. Above all, preferred is laminate paper from the viewpoint of the surface smoothness. Preferred for use herein are polyethylene-laminated paper (this may be abbreviated as WP paper) analogues, or that is, a support comprising cellulose as the main ingredient and coated with a polyolefin resin on at least its surface to be coated with a receiving layer.

### —Coated Paper—

The coated paper is a type of paper prepared by applying various resin, rubber latex or polymer material onto one or both surfaces of a sheet of raw paper. Depending on its use, the coating amount varies. The coated paper includes, for example, art paper, cast coated paper, Yankee paper.

As the resin to be applied to the surface of the raw paper, it is suitable to use a thermoplastic resin. The thermoplastic resin includes, for example, the following resins (a) to (h).

(a) This group includes polyolefin resins such as polyethylene resin, polypropylene resin; copolymer resins of olefin such as ethylene or propylene with any other vinyl monomer; acrylic resins.
(b) This is an ester bond-having thermoplastic resin. It includes, for example, polyester resins obtained through condensation of a dicarboxylic acid component (the dicarboxylic acid component may be substituted with a sulfonic acid group or a carboxylic acid group) and an alcohol component (the alcohol component may be substituted with a hydroxyl group); polyacrylate resins or polymethacrylate resins such as polymethyl methacrylate, polybutyl methacrylate, polymethyl acrylate, polybutyl acrylate; polycarbonate resins, polyvinyl acetate resins, styrene-acrylate resins, styrene-methacrylate copolymer resins, vinyltoluene-acrylate resins.

Concretely, there are mentioned the resins described in JP-A 59-101395, 63-7971, 63-7972, 63-7973, 60-294862.

Commercial products of various thermoplastic resins usable herein are Toyobo's Vylon 290, Vylon 200, Vylon 280, Vylon 300, Vylon 103, Vylon GK-140, Vylon GK-130; Kao's Tafton NE-382, Tafton U-5, ATR-2009, ATR-2010; Unitika's Elitel UE3500, UE3210, XA-8153, KZA-7049, KZA-1449; Nippon Synthetic Chemical's Polyester TP-220, R-1BB; Seiko Chemical Industry's Hi-Ros Series (all trade names).

(c) This includes polyurethane resins.

(d) This includes polyamide resins and urea resins.

(e) This includes polysulfone resins.

(f) This includes polyvinyl chloride resins, polyvinylidene chloride resins, vinyl chloride-vinyl acetate copolymer resins, vinyl chloride-vinyl propionate copolymer resins.

(g) This includes polyol resins such as polyvinyl butyral; and cellulose resins such as ethyl cellulose resins, cellulose acetate resins.

(h) This includes polycaprolactone resins, styrene-maleic anhydride resins, polyacrylonitrile resins, polyether resins, epoxy resins, phenolic resins.

One or more of the above-mentioned thermoplastic resins may be used herein either singly or as combined.

If desired, brightener, conductive agent, filler, titanium oxide, ultramarine, carbon black, and other pigment or dye may be added to the thermoplastic resin.

### —Laminate Paper—

The laminate paper is a type of paper produced by laminating various resin, rubber or polymer sheet or film on a sheet of raw paper. The laminate material includes, for example, polyolefin, polyvinyl chlorides polyethylene terephthalate, polystyrene, polymethacrylate, polycarbonate, polyimide, triacetyl cellulose. One or more these resins may be used either singly or as combined.

As the polyolefin, generally used is low-density polyethylene. For increasing the heat resistance of the support, preferably used is polypropylene, a blend of polypropylene and polyethylene, high-density polyethylene, or a blend of high-density polyethylene and low-density polyethylene. In particular, from the viewpoint of the cost and the lamination aptitude, most preferred is a blend of high-density polyethylene and low-density polyethylene.

The blend of high-density polyethylene and low-density polyethylene is used, for example, in a blend ratio (by mass) of from 1/9 to 9/1. The blend ratio is preferably from 2/8 to 8/2, more preferably from 3/7 to 7/3. In case where the thermoplastic resin layer is formed on both surfaces of the support, it is desirable that high-density polyethylene or a blend of high-density polyethylene and low-density polyethylene is applied to the back of the support to form a laminate layer thereon. The molecular weight of polyethylene is not specifically defined. Preferably, high-density polyethylene and low-density polyethylene both have a melt index of from 1.0 to 40 g/10 min, and have good extrudability.

The sheet or the film may be processed for white reflectivity. For the treatment, for example, employable is a method of adding a pigment such as titanium oxide to the sheet or the film. It has been generally used as a support for photographic paper in the filed of silver salt photography (it may be abbreviated as WP paper).

The thickness of the support is preferably from 25 μm to 300 μm, more preferably from 50 μm to 260 μm, even more preferably from 75 μm to 220 μm. The rigidity of the support may be on a different level, depending on the use thereof. As the support for electrophotographic image-receiving sheets for photograph-level image quality, it is preferably near to the support for silver salt color photography.

### (Curl-Controlling Layer)

When the support is directly exposed out, the thermal transfer image-receiving sheet may curl depending on the humidity and the temperature in the environment. Accordingly, a curl-controlling layer is preferably formed on the back of the support. The curl-controlling layer acts not only for preventing the image-receiving sheet from curling but also for waterproofness. For the curl-controlling layer, usable is a polyethylene laminate or a polypropylene laminate. Concretely, for example, the layer may be formed as in JP-A 61-110135, 6-202295.

### (Writing Layer, Static Charge-Controlling Layer)

For the writing layer and the static charge-controlling layer, usable are inorganic oxide colloid, ionic polymer, etc. As the antistatic layer, for example, usable is any of a cationic antistatic agent such as quaternary ammonium salts, polyamine derivatives; an anionic antistatic agent such as alkylphosphates; and a nonionic antistatic agent such as fatty acid esters. Concretely, for example, the layer may be formed in the same manner as in Japanese Patent 3565585.

A method for producing the thermal transfer image-receiving sheet of the invention is described below.

The thermal transfer image-receiving sheet of the invention is produced by forming at least one image-receiving layer and at least one heat-insulating layer on a support according to water-base coating thereon. The coating method may be suitably selected from known methods.

An embodiment of having at least two image-receiving layers and at least two heat-insulating layers is also preferred, and when at least the adjacent constitutive layers are formed by water-base coating, it is desirable that these are formed by simultaneous multilayer coating.

In case where a multilayer-structured image-receiving sheet is fabricated, which comprises plural layers having plural different functions (foam layer, heat-insulating layer, interlayer, receiving layer) formed on a support, there are known some methods. For example, the constitutive layers are successively formed by coating, as in JP-A 2004-106283, 2004-181888, 2004-345267; or the layers are previously formed on separate supports, and they are laminated together. On the other hand, in the field of photography, for example, it is known that plural layers are simultaneously formed by coating, whereby the producibility may be greatly improved. For example, known are a slide coating method and a curtain coating method, as described in U.S. Pat. No. 2,761,791, U.S. Pat. No. 2,681,234, U.S. Pat. No. 3,508,947, U.S. Pat. No. 4,457,256, U.S. Pat. No. 3,993,019; JP-A 63-54975, 61-278848, 55-86557, 52-31727, 55-142565, 50-43140, 63-80872, 54-54020, 5-104061, 5-127305, JP-B 49-7050, or in Edgar B. Cutoff, et al., “Coating and Drying Defects: Troubleshooting Operating Problems”, John Wiley & Sons, 1995, pp. 101-103. In these coating methods, plural coating liquids are supplied to a coating device at the same time, thereby forming different plural layers.

In the invention, the above-mentioned simultaneous multilayer coating technique is applied to the production of a multilayer-structured image-receiving sheet, whereby the invention can efficiently exhibit its effect therefore giving a thermal transfer image-receiving sheet which has excellent in-line travelability when combined with an ink sheet for image printing thereon. In addition, the adhesiveness between the Coating layers of the obtained thermal transfer image-receiving sheet is good, and even when the printed sheet is repeatedly posted with adhesive tape, it hardly has a trouble of delamination of the constitutive layers. Further, the producibility in producing the sheet is greatly improved.

In the simultaneous multilayer coating operation, the viscosity and the surface tension of the coating liquids to form the constitutive layers must be controlled from the viewpoint of homogeneous coating film formation and good coatability. The viscosity of the coating liquid may be readily controlled by using a known thickener or thinner within a range not having influences on the other properties of the liquid. The surface tension of the coating liquid may be controlled by various surfactants.

In the invention, resin is the main ingredient of the plural constitutive layers. Preferably, the coating liquids for the layers are in the form of polymer latex. The solid content by weight of the resin as a latex in the coating liquid for the layers is preferably from 5 to 80%, more preferably from 20 to 60%. The mean particle size of the resin in the polymer latex is preferably at most 5 μm, more preferably at most 1 μm. If desired, the polymer latex may contain a known additive such as surfactant, dispersant, binder resin.

The coating liquid temperature is preferably from 25° C. to 60° C., more preferably from 30° C. to 50° C.

In the invention, it is desirable that a laminate of plural layers is formed on a support according to the method described in U.S. Pat. No. 2,761,791, and then rapidly solidified. In case where a multilayer constitution is formed through resin solidification in one example, it is desirable that plural layers are formed on a support and then immediately heated. In case where the layer contains a binder capable of gelling at a low temperature, such as gelatin, it may be desirable that plural layers are formed on a support and the temperature is then immediately lowered to thereby cool and solidify the coating film, and thereafter this is dried by heating.

One example of the cooling method comprises applying cold water to the coating film. The temperature of the cold air is preferably not higher than 25° C., more preferably not higher than 15° C., even more preferably not higher than 10° C. The time for which the coating film is exposed to cold air is preferably at least 15 seconds, through varying depending on the coating and conveying speed. For promoting the gellation, the ratio by mass of the binder may be increased or a known gelling agent may be used.

In the invention, the coating amount of the coating liquid per one layer to constitute the multilayer constitution is preferably within a range of from 1 g/m² to 500 g/m². The number of the layers of the multilayer constitution may be 2 or more, and may be suitably selected. Preferably, the receiving layer is provided as the remotest layer from the support.

The thermal transfer image-receiving sheet of the invention is produced according to the above-mentioned coating method preferably comprising simultaneous multilayer coating and drying. In the invention, latex is the main ingredient of the coating liquid, and therefore, when the coating film is dried rapidly, then the film may unevenly shrunk by the drying and may be often cracked after the drying. Accordingly, it is desirable that the coating film is dried slowly.

To satisfy the requirements, in the drying step, the coating film must be dried while controlling the drying temperature, the drying air flow rate and the dew point of the drying air and further controlling the drying speed.

In thermal transfer image formation, the thermal transfer sheet (ink sheet) to be combined with the thermal transfer image-receiving sheet of the invention comprises a dye layer containing a diffusive transfer dye, formed on a support. Any desired ink sheet may be used herein. The method of applying heat energy in thermal transfer may be any known conventional method. For example, using a recording device such as thermal printer (e.g., FUJIFILM's trade name, ASK-2000), the recording time may be controlled, and heat energy of from 0 to 50 mJ/mm² or so may be given to the sheet to fully attain the intended object.

For the thermal transfer image-receiving sheet, the support may be suitably selected. Depending on the type of the support selected for it, the thermal transfer image-receiving sheet of the invention may be in any form of cut sheets, rolls, cards, or sheets for producing transmissive originals. The invention is directed to any of these applications.

The invention is applicable to thermal transfer recording-type printers and copiers.

### EXAMPLES

The invention is described in more detail with reference to the following Examples and Reference Examples. In Examples, the material used, its amount and the ratio, the details of the treatment and the treatment process may be suitably modified or changed not overstepping the scope of the invention. Accordingly, the invention should not be limitatively interpreted by the Examples mentioned below. Unless otherwise specifically indicated, part and % in Examples are all by mass.

### (1) Fabrication of Thermal Transfer Image-Receiving Sheet:

### (Formation of Support)

Using a disc refiner, 50 parts by mass of LBKP (Laubholz (broadleaf tree) bleached kraft pulp) of acacia and 50 parts by mass of LBKP of aspen were beaten to a Canadian freeness of 300 ml to prepare a pulp slurry.

Next, to the above-obtained pulp slurry, added were 1.3%, relative to the pulp, of cation-modified starch (Nippon NSCTS trade name, CAT0304L), 0.15% of anion-modified polyacrylamide (Seiko FMC's trade name, DA4104), 0.29% of alkylketene dimer (Arakawa Chemicals trade name, Sizepine K), 0.29% of behenylamide epoxide, and 0.32% of polyamide-polyamine-epichlorohydrin (Arakawa Chemical's trade name, Arafix 100), and then 0.12% of a defoaming agent was added thereto.

Using a Fourdrinier paper machine, the pulp slurry prepared in the manner as above was made into paper. In the step of drying the web by pressing its felt surface against a drum drier cylinder via a drier canvas, the tension of the drier canvas was set at 1.6 kg/cm, and the web was dried in that condition. Then, using a size press, polyvinyl alcohol (Kuraray's trade name, KL-118) was applied to both surfaces of the raw paper in an amount of 1 g/m², and dried, and then calendered. The papermaking condition was so controlled that the formed raw paper (base paper) could have a weight of 157 g/n2 and a thickness of 160 μm.

The wire surface (back) of the obtained base paper was processed for corona discharge treatment. Next; using a melt extruder, a resin composition prepared by blending a high-density polyethyl ene having MNR (melt flow rate—the same shall apply hereunder): 16.0 g/10 min, density: 0.96 g/cm³) (containing 250 ppm of hydrotalcite (Kyowa Chemical Industry's trade name, DHT-4A), and 200 ppm of secondary antioxidant (tris(2,4-di-tert-butylphenyl phosphite, Ciba Specialty Chemicals' trade name, Irgafos 168)), and a low-density polyethylene having MFR of 4.0 g/10 min and a density of 0.93 g/cm³ in a blend ratio of 75/25 (by mass) was applied onto it to a thickness of 21 g/m², thereby forming a thermoplastic resin layer with a mat surface (the thermoplastic resin back face is hereinafter referred to as “back”). The thermoplastic resin layer on the back side was further processed for corona discharge treatment, and then an aqueous dispersion prepared by dispersing an antistatic agent, aluminium oxide (Nissan Chemical Industry's trade name, Alumina Sol 100) and silicon dioxide (Nissan Chemical Industry's trade name, Snowtex 0) in water in a ratio by mass of 1/2, was applied onto it to a dry mass of 0.2 g/m². Next, the surface was processed for corona treatment, and using a melt extruder, a low-density polyethylene having MFR of 4.0 g/10 min and a density of 0.93 g/m³ and containing 10% by mass of titanium oxide was applied onto it in an amount of 27 g/m², thereby forming a thermoplastic resin layer with a mirror surface.

### (Fabrication of Image-Receiving Sheet)

On the support prepared in the manner as above, formed were an undercoat layer 1, an undercoat layer 2, a heat-insulating layer and a receiving layer in that order from the support, thereby fabricating an image-receiving layer. The compositions of the coating liquids and their amount used in fabricating a sample 101 are shown below.

The coating mode is simultaneous multilayer coating of forming all the layers at the same time. The coating was slide coating. After the coating, the sample was led to pass through a set zone at 6° C., taking 30 seconds, whereby the coating liquid lost its fluidity, and then drying air at 22° C. and a relative humidity of 45% was applied to the coated surface for 2 minutes to dry it.

### Coating Liquid for Undercoat Layer 1:

### (Composition)

This is an aqueous solution prepared by adding 1% of sodium dodecylbenzenesulfonate to an aqueous 3% gelatin solution. Its pH was controlled to 8 with NaOH.

| | |
|---|---|
| (Coating Amount) | 11 ml/m². |
| Coating Liquid for undercoat layer 2: | |
| (Composition) | |
| Styrene-butadiene latex | 60 mas.pts. |
| (Nippon A & L's SR103) | |
| Polyvinyl alcohol (PVA) 6% aqueous solution | 40 mas.pts. |
| Surfactant 1% aqueous solution (BFS-1) | 2 mas.pts. |
| Controlled at pH 8 with NaOH. | |
| (Coating Amount) | 11 ml/m². |
| (Viscosity of Coating Liquid) | 50 cp. |
| Coating Liquid for heat-insulating layer: | |
| (Composition) | |
| Emulsion A prepared below | 21 mas.pts. |
| Hollow polymer (Nippon Zeon's MH5055) | 48 mas.pts. |
| 10% gelatin aqueous solution | 28 mas.pts. |
| Water | 3 mas.pts. |
| Preservative (compound of formula PR-1) | 0.2 mas.pts. |
| Controlled at pH 8 with NaOH. | |
| (Coating Amount) | 50 ml/m². |
| (Viscosity of Coating Liquid) | 45 cp. |
| Coating Liquid for receiving layer: | |
| (Composition) | |
| Emulsion B prepared below | 4 mas.pts. |
| Vinyl chloride-type polymer latex | 53 mas.pts. |
| (Nisshin Chemical's Vinybran 900) | |
| Vinyl chloride-type polymer latex | 10 mas.pts. |
| (Nisshin Chemical's Vinybran 276) | |
| Microcrystalline wax | 6 mas.pts. |
| (Nippon Seiro's EMUSTAR-42X) | |
| Water | 22 mas.pts. |
| Surfactant 1% aqueous solution (BFS-1) | 4 mas.pts. |
| Mat agent (melamine-silica resin, | 1 mas.pt. |
| specific gravity 1.65 (Nissan | |
| Chemical Industry's Optobeads 3500M) | |
| Preservative (compound of formula PR-1) | 0.1 mas.pts. |
| Controlled at pH 8 with NaOH. | |
| (Coating Amount) | 18 ml/m². |
| (Viscosity of Coating Liquid) | 7 cp. |

(PR-1)

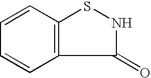

### (Preparation of Emulsion A)

An emulsion A was prepared as follows: A compound EB-9 was dissolved in a high-boiling-point solvent (Solv-5) (42 g) and ethyl acetate (20 ml), and the solution was emulsified and dispersed in an aqueous 20 mas.% gelatin solution (250 g) containing sodium dodecylbenzenesulfonate (1 g), using a high-speed stirring emulsifying machine (dissolver). Water was added to it to prepare an emulsion A (380 g).

In this, the amount of the compound EB-9 was so controlled that its amount could be 30 mmol in the emulsion A. However, in the actual experiments, the production scale was modified according to the necessary amount. In this case, the ratio of each additive and each solvent was made to be the same as the above.

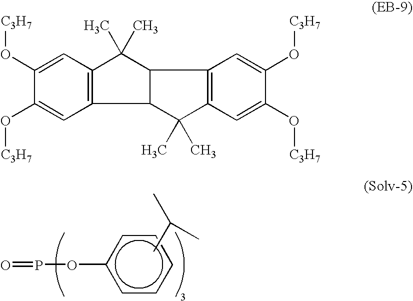

### (Preparation of Emulsion B)

A high-boiling-point solvent (Solv-5) (11.0 g), KE-96 (Shin-etsu Chemical's dimethylsilicone) (9 g), the above compound (EB-9) (15.5 g), KAYAPAD DPCA-30 (by Nippon Kayaku) (7.5 g) and ethyl acetate (20 ml) were formed into a solution, and the solution was emulsified and dispersed in an aqueous 20 mas.% gelatin solution (250 g) containing sodium dodecylbenzenesulfonate (1 g), using a high-speed stirring emulsifying machine (dissolver). Water was added to it to prepare an emulsion B (380 g). However, in the actual experiments, the production scale was modified according to the necessary amount. In this case, the ratio of each additive and each solvent was made to be the same as the above.

Zn this experiment, the coating liquids for the layers as above were forcedly deteriorated, each with stirring at 40° C. for 78 hours, and then used for coating.

In the samples 102 to 106, 110 and 112, the defoaming agent shown in Table 1 was added to the coating liquid in an amount of 0.5% by mass. The samples 109 and 110 were fabricated in the same manner as that for the samples 101 and 109; but in the former two, the undercoat layer 1, the undercoat layer 2, the heat-insulating layer and the receiving layer were not formed by simultaneous multilayer coating. In these, the undercoat layers 1 and 2 were formed by simultaneous coating and dried, and then the heat-insulating layer and the receiving layer were successively formed one by one and dried, thereby fabricating the samples 109 and 110. The samples 111 and 112 were fabricated in the same manner as that for the samples 101 and 108; but in the former two, the hollow polymer was removed from the heat-insulating layer.

### (2) Fabrication of Ink Sheet:

A polyester film (Lumirror, trade name by Toray) having a thickness of 6.0 μm was used as a support film. A heat-resistant slip layer (thickness 1 μm) was formed on the back of the film, and yellow, magenta and cyan compositions mentioned below were applied each as single color (coating amount of the dry film, 1 g/m²).

### Yellow Composition:

| | | |
|---|---|---|
| Dye (Macrolex Yellow 60, trade name by Bayer) | 5.5 | mas. pts. |
| Polyvinyl butyral resin (Eslec BX-1, trade name by | 4.5 | mas. pts. |
| Sekisui Chemical Industry) | | |
| Methyl ethyl ketone/toluene (1/1 by mass) | 90 | mas. pts. |
| Magenta composition: | | |
| Magenta dye (Disperse Red 60) | 5.5 | mas. pts. |
| Polyvinyl butyral resin (Eslec BX-l, trade name by | 4.5 | mas. pts. |
| Sekisui Chemical Industry) | | |
| Methyl ethyl ketone/toluene (1/1 by mass) | 90 | mas. pts. |
| Cyan composition: | | |
| Cyan dye (Solvent Blue 63) | 5.5 | mas. pts. |
| Polyvinyl butyral resin (Eslec BX-1, trade name by | 4.5 | mas. pts. |
| Sekisui Chemical Industry) | | |
| Methyl ethyl ketone/toluene (1/1 by mass) | 90 | mas. pts. |

### (3) Fabrication of Protective Layer Sheet:

A protective layer and an adhesive layer each having the composition mentioned below were formed on the same polyester film as that used in fabricating the ink sheet. The dry coating amount of the protective layer was 1 g/m² and that of the adhesive layer was 0.7 g/m². The adhesive layer was formed on the protective layer by coating, after the protective layer was formed and dried.

### Protective Layer:

| | | |
|---|---|---|
| Acrylic resin (Dianal BR-80, trade name by | 20 | mas. pts. |
| Mitsubishi Rayon) | | |
| Methyl ethyl ketone/toluene (1/1 by mass) | 80 | mas. pts. |
| Adhesive Layer: | | |
| Polyester resin (Vylon 220, trade name by Toyobo) | 30 | mas. pts. |
| Methyl ethyl ketone/toluene (1/1 by mass) | 70 | mas. pts. |

### (4) Image Formation and Property Evaluation:

### (Image Formation)

The above ink sheet, the above protective layer sheet and the above image-receiving were tested for image formation. Using a thermal transfer printer (ASK-2000, by FUJIFILM), images having a size of 152 mm×102 mm were outputted. The running speed was 73 mm/sec.

### (Property Evaluation)

The formed images were evaluated in point of the following matters.

### (Image Uniformity, Image Confusion)

Five prints having a visual density of 1.0 were continuously outputted, and visually checked fox the presence or absence of pin holes and density unevenness in the prints.

According to the following criteria, the prints were evaluated for the image uniformity. 20 panelists checked the print samples, and their points were averaged.

5: No image confusion found in prints.
4: Little image confusion found in prints.
3: Image confusion found in prints, but no problem in practical use.
2: Some image confusion found in prints, and this was problematic in practical use.
1: Much image confusion found in prints, which disturbed recognition of printed images.

### (Dmax)

A black solid image was outputted, and the maximum color density was measured. In visual density measurement, the data obtained are shown as a relative value to the sample 101. Samples having a higher value are better, as having a sharper image.

The results are shown in Table 1 below.

TABLE 1

| | Defoaming | Layer with Defoaming | Image | | |
|---|---|---|---|---|---|
| Sample | Agent | Agent Added | Uniformity | Dmax | Remarks |
| Sample 101 | — | — | 1.5 | 100 | simultaneous |
| (Comparative Example) | | | | | multilayer coating |
| Sample 1.02 | a | receiving layer | 2.5 | 99 | simultaneous |
| (the Invention) | | | | | multilayer coating |
| Sample 103 | b | receiving layer | 3.6 | 101 | simultaneous |
| (the Invention) | | | | | multilayer coating |
| Sample 104 | c | receiving layer | 3.7 | 102 | simultaneous |
| (the Invention) | | | | | multilayer coating |
| Sample 105 | d | receiving layer | 2.6 | 98 | simultaneous |
| (the Invention) | | | | | multilayer coating |
| Sample 106 | e | receiving layer | 2.7 | 99 | simultaneous |
| (the Invention) | | | | | multilayer coating |
| Sample 107 | f | receiving layer | 2.9 | 101 | simultaneous |
| (the Invention) | | | | | multilayer coating |
| Sample 108 | c | recieving layer | 4.7 | 100 | simultaneous |
| (the Invention) | | and heat-insulating layer | | | multilayer coating |
| Sample 109 | — | — | 1.3 | 97 | not simultaneous |
| (Comparative Example) | | | | | multilayer coating |
| Sample 110 | c | receiving layer | 3.5 | 99 | not simultaneous |
| (the Invention) | | and heat-insulating layer | | | multilayer coating |
| Sample 111 | — | — | 1.5 | 60 | simultaneous |
| (Comparative Example) | | | | | multilayer coating; |
| Sample 112 | c | recieving layer | 4.7 | 62 | no hollow polymer in |
| (the Invention) | | and heat-insulating layer | | | heat-insulating layer |
| | | | | | no hollow polymer in |
| | | | | | heat-insulating layer |

a methanol
b 2-ethylhexanol
c LG-109 (by Asahi Denka Kogyo)
d BY28-503 (by Toray Dow Corning Silicone)
e (C₂H₅)₂CHCOO(C₂H₄O)₄H
f (C₆H₁₄)₂CHCOO(C₂H₄O)₄H

From Table 1, it is obvious that the samples of the invention are excellent in the image uniformity as compared with the comparative samples. It is known that the effect of adding the defoaming agent is more remarkable in simultaneous multilayer coating (comparison between the sample 108 and the sample 110). When a hollow polymer is used in the heat-insulating layer, then it brings about the advantages of excellent image uniformity and high Dmax (comparison between the sample 108 and the sample 112).

The present disclosure relates to the subject matter contained in Japanese Patent Application No. 092497/2007 filed on Mar. 30, 2007, which is expressly incorporated herein by reference in its entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A thermal transfer image-receiving sheet comprising, on a support, at least one image-receiving layer containing at least one polymer latex and comprising at least one heat-insulating layer between the receiving layer and the support, wherein at least one layer on the support is formed by water-base coating and at least one layer on the support contains a defoaming agent.

2. The thermal transfer image-receiving sheet according to claim 1, wherein the heat-insulating layer contains at least one hollow polymer and is formed by water-base coating.

3. The thermal transfer image-receiving sheet according to claim 1, wherein at least two layers on the support are formed by simultaneous multilayer coating.

4. A method for producing a thermal transfer image-receiving sheet comprising, on a support, at least one image-receiving layer containing at least one polymer latex, comprising at least one heat-insulating layer between the receiving layer and the support, and containing a defoaming agent in at least one layer on the support, which comprises forming at least one layer on the support by water-base coating.

5. The method for producing a thermal transfer image-receiving sheet according to claim 4, wherein the heat-insulating layer contains at least one hollow polymer and the heat-insulating layer is formed by water-base coating.

6. The method for producing a thermal transfer image-receiving sheet according to claim 4, wherein at least two layers on the support are formed by simultaneous multilayer coating.
